(19) United States
(12) Patent Application Publication
(10) Pub. No.: US 2024/0420083 A1
(43) Pub. Date: Dec. 19, 2024

(54) DIGITAL WORK COLLABORATIVE CREATION METHOD, ELECTRONIC DEVICE AND COMPUTER-READABLE STORAGE MEDIUM

(71) Applicant: BEIJING QISUI TECHNOLOGIES CO., LTD, Beijing (CN)

(72) Inventors: Jincan ZHU, Beijing (CN); Congxing OUYANG, Beijing (CN); Jianming ZHOU, Beijing (CN)

(21) Appl. No.: 18/820,736

(22) Filed: Aug. 30, 2024

Related U.S. Application Data
(63) Continuation-in-part of application No. PCT/CN2022/107249, filed on Jul. 22, 2022.

(30) Foreign Application Priority Data
Mar. 1, 2022 (CN) 202210195727.4

(51) Int. Cl. G06Q 10/101

(52) U.S. Cl. CPC G06Q 10/101

(57) ABSTRACT

According to a digital work collaborative creation method, a collaborative creation task is divided into a plurality of sub-tasks which have a dependency relationship and which comprise subtask description information, so that the collaborative creation task can be divided into sub-tasks which have finer granularity and the dependency relationship for creators to create. Sub-tasks in a creatable state are provided to the creators to input creation information according to the subtask description information. Creation information of the creators for the sub-tasks is received to generate execution content of the sub-task, and achieve the collaborative creation of digital work, creators skilled in the field of the sub-task can create according to a creation state to ensure that tasks are created in the correct order and on the basis of consummate basic information, thereby providing a more effective mode for the collaborative creation of tasks. Thus, the defects in the prior art that creation methods for digital work carry high costs, are complex to manage, and do not allow for the full exertion of the professional expertise of professionals are overcome.

### CROSS-REFERENCE TO RELATED APPLICATION

The present application is a continuation-in-part of International Application Ser. No. PCT/CN2022/107249 filed Jul. 22, 2022, which claims priority to Chinese patent application No. 202210195727.4, filed Mar. 1, 2022, and entitled “Digital Work Collaborative Creation Method, and Task Release Method and Apparatuses”, the disclosures of which are hereby incorporated by reference in their entireties.

### TECHNICAL FIELD

The present application relates to the field of digital information, in particular to a digital work collaborative creation method, an electronic device and a computer-readable storage medium.

### BACKGROUND

With the development and popularization of an information technology, people are moving towards the information age. A significant feature of the information age is that in both the real world and virtual worlds such as the metaverse, more and more production activities of the human society take digital works such as documents, design models and multimedia works as production carriers. The information age further has a significant feature of “information explosion”. New concept and new knowledge emerge continuously, a human knowledge system expands continuously, and various cross professional fields or even new professional fields are promoted continuously. In the information age, the cost of large-scale collaboration across the time and space of human beings is increasingly lower, thereby driving the degree of division of labor based on specialization of the human society to be increasingly improved, the professional fields to be increasingly refined, and the human society production relationship to be more and more complicated. At the same time, as machine intelligence has arisen, more and more programmable information processing needs may be accepted by a machine. Furthermore, with the widespread popularization of information technology tools such as a mobile intelligent terminal, and deep fusion of various application software and human activities, more and more people master the capability of using an intelligent device and application software to create a digital content; creating the digital content according to their interests and hobbies by relying on their own ability endowment and knowledge background, and using creativity, aesthetic capability, and goodness.

The digital works such as patent evaluation reports, industry analysis reports, research reports, evaluation reports, and metaverse virtual parks involve multiple professional fields and require collaborative creation by teams composed of people from multiple fields. At present, in order to complete a creation task of such digital works, a demander of such digital works needs to package the creation task of the entire digital works into a project, and then entrust the project to a certain service team in the demander or a certain external service agency as a project undertaker.

Due to the involvement of the multiple professional fields in such projects, it is difficult for an individual to undertake project tasks solely based on their professional abilities. The individual usually has to rely on a certain organization, such as a team or institution, so as to undertake the project tasks from which. Afterwards, the organization will assign certain subtasks in the project tasks to individuals to complete.

This project entrusting manner, which takes the creation task of the entire digital work as the granularity, has the following problems:
1) the project undertaker needs to form a project team for the project and organize multiple professionals to carry out collaborative creation, which brings high project organization costs, including communication costs, trust costs, management costs, etc. If there is a field relatively strange to the project undertaker in the multiple professional fields involved in the creation task of the digital work, the project organization costs are higher in order to find a suitable related-field professional, and the project progress will also be subject to a process of finding the suitable related-field professional and a communication process. Furthermore, under the dominance of the project undertaker, the project team is often an enterprise or an institution, which usually puts forward centralized office demands. Due to factors such as traffic, time, and epidemic situation, the centralized office demands further increases the organization costs and reduces creation efficiency.
2) The professional needs to be attached to the certain organization to have an opportunity to participate in the creation task of the digital work. This enables the professional to be subject to a management system of that organization. In an organization system, some factors that are not directly related to the creation task, such as an interpersonal relationship, a performance evaluation, and compensation allocation, are likely to generate an internal problem such as an unpleasant emotion, and cause negative interference to a work developed by the professional, and may also lead to the resignation of some professionals. After the resignation of the professionals, it becomes difficult for them to participate in digital work creation activities. On the one hand, this phenomenon lowers the income and living standards of these professionals; and on the other hand, valuable human resources are also wasted.
3) Each professional's interests and hobbies, ability endowment, and knowledge background are usually oriented. Therefore, in terms of digital content creation, each professional usually has a professional field that he/she likes and specializes. In the digital content creation work that people like and specialize, their work efficiency and creation quality will have significant comparative advantages. This also means that the digital content creation work that each professional likes and specializes is usually only a part of the entire digital work creation task. Because of a coarse granularity of current project entrusting, the work amount of the digital content creation that the professional likes and specializes will not be too large in all projects undertaken by the organization to which the professional is attached. This also means that in view of the demands of various project tasks undertaken by the organization, each professional often needs to put some of his/her own time and effort on affairs that he/she does not like and specialize. Such a situation makes it impossible for many professionals to fully implement their comparative advantages, resulting in a waste of human resources.

### SUMMARY OF THE INVENTION

Therefore, the technical problem to be solved by the present application is to overcome defects in the prior art of high cost, complex management, and inability to fully utilize the professional expertise of professionals in a digital work creation method, so as to provide a digital work collaborative creation method, an electronic device and a computer-readable storage medium.

According to a first aspect, an implementation of the present application provides a digital work collaborative creation method, including:
obtaining a collaborative creation task, wherein the collaborative creation task includes a plurality of subtasks, each of the subtasks includes subtask description information, and a dependency relationship exists among the subtasks;
obtaining creation states of the subtasks, wherein the creation states include a creatable state and a non-creatable state, and the creation states are set according to the dependency relationship among the subtasks;
providing a subtask in the creatable state to a creator for the creator to input created information according to the subtask description information; and
receiving the created information from the creator for the subtask, and generating an execution content corresponding to the subtask.

According to the digital work collaborative creation method in this implementation, a task to be collaboratively created is divided into subtasks which have finer granularity and the dependency relationship for the creator to create, and the creation states of the subtasks are set according to the dependency relationship among the subtasks. Creators may create according to the creation states to ensure that tasks are created in a correct order and on the basis of consummate basic information, thereby providing a more effective mode for the collaborative creation of the tasks. Thus, the defects in the prior art that the creation methods for the digital work carry high collaborative costs, are complex to manage, and do not allow for the full exertion of the professional expertise of professionals are overcome.

According to a second aspect, an implementation of the present application further provides a method for releasing a digital work collaborative creation task, including:
obtaining a selected task template, wherein the task template includes template description information, a task setting object, and subtasks, each of the subtasks includes subtask description information, and a dependency relationship exists among the subtasks;
providing the task setting object to a task releaser for the task releaser to input task setting information; and
generating and releasing a collaborative creation task according to the task setting information input by the task releaser and the task template.

According to a third aspect, an implementation of the present application further provides a digital work collaborative creation apparatus, including:
a task obtaining unit, configured to obtain a collaborative creation task, wherein the collaborative creation task includes a plurality of subtasks, each of the subtasks includes subtask description information, and a dependency relationship exists among the subtasks;
a state obtaining unit, configured to obtain creation states of the subtasks, wherein the creation states include a creatable state and a non-creatable state, and the creation states are set according to the dependency relationship among the subtasks;
a creation providing unit, configured to provide a subtask in the creatable state to a creator for the creator to input created information according to the subtask description information; and
a content generating unit, configured to receive the created information from the creator for the subtask, and generate an execution content corresponding to the subtask.

According to a fourth aspect, an implementation of the present application further provides an apparatus for releasing a digital work collaborative creation task, including:
a template selecting unit, configured to obtain a selected task template, wherein the task template includes template description information, a task setting object, and subtasks, each of the subtasks includes subtask description information, and a dependency relationship exists among the subtasks;
a providing unit, configured to provide the task setting object to a task releaser for the task releaser to input task setting information; and
a releasing unit, configured to generate and release a collaborative creation task according to the task setting information input by the task releaser and the task template.

According to a fifth aspect, an implementation of the present application further provides an electronic device, including: a memory and a processor, wherein the memory and the processor are in communicational connection with each other, the memory has computer instructions stored therein, and the processor is configured to execute the digital work collaborative creation method above or the method for releasing a digital work collaborative creation task above by executing the computer instructions.

According to a sixth aspect, an implementation of the present application further provides a computer-readable storage medium, wherein the computer-readable storage medium has computer instructions stored therein, and the computer instructions are configured to cause a computer to execute the digital work collaborative creation method above or the method for releasing a digital work collaborative creation task above.

### BRIEF DESCRIPTION OF THE DRAWINGS

In order to illustrate specific implementations of the present application or technical solutions in the prior art more clearly, accompanying drawings needing to be used in description of the specific implementations or the prior art will be introduced below briefly. Apparently, the accompanying drawings in the description below are some implementations of the present application, and those ordinarily skilled in the art can further obtain other accompanying drawings according to these accompanying drawings without inventive efforts.

FIG. 1 is a flow diagram of a method for releasing a digital work collaborative creation task in an implementation of the present application.

FIG. 2 is a flow diagram of a digital work collaborative creation method in an implementation of the present application.

FIG. 3-1 to FIG. 3-10 are corresponding schematic diagrams in specific embodiments of collaborative creation of a patent value evaluation report.

FIG. 4-1 to FIG. 4-6 are corresponding schematic diagrams in specific embodiments of collaborative creation of a metaverse theme park.

FIG. 5 is a block diagram of an apparatus for releasing a digital work collaborative creation task in an implementation of the present application.

FIG. 6 is a block diagram of a digital work collaborative creation apparatus in an implementation of the present application.

FIG. 7 is a structural block diagram of a computer device in an implementation of the present application.

### DETAILED DESCRIPTION

The technical solutions of the present application will be described below clearly and completely with reference to the accompanying drawings. Apparently, the described embodiments are only part of the embodiments of the present application, but not all the embodiments. On the basis of the embodiments in the present application, all other embodiments obtained by those ordinarily skilled in the art without inventive efforts fall within the protection scope of the present application.

In addition, the technical features involved in different implementations of the present application described below can be combined with each other as long as they do not conflict with each other.

In order to meet collaborative creation needs of digital works involving multiple professional fields, for example, the collaborative creation needs such as a patent evaluation report, an industry analysis report, a research report, an evaluation report, and metaverse park design, this embodiment provides a digital work collaborative creation method that establishes a connection between a demander and numerous individuals with different professional abilities for collaborative creation.

The digital work collaborative creation method provided by this embodiment may be implemented through digital work collaborative creation software. The digital work collaborative creation software includes a server side and a client side. The digital work collaborative creation method is used on the server side, its execution subject may be a digital work collaborative creation apparatus, and the apparatus may be implemented as part or all of a computer device through software, hardware, or a manner of combining software and hardware, wherein the computer device may be a server or a terminal. The server in the embodiment of the present application may be a single server or a server cluster composed of a plurality of servers. The terminal in the embodiment of the present application may be other intelligent hardware devices such as a smartphone, a personal computer, a tablet, a wearable device, an intelligent robot, a computer/server. A user accesses the server side through client sides on the intelligent hardware devices such as the smartphone, the tablet, a computer/server, and a dedicated handheld terminal to carry out collaborative creation activities (hereinafter, collectively refer to as “user terminal”). In the following method embodiments, illustration is made by taking an example that the execution subject is the computer device.

First, this embodiment provides a digital work collaborative creation method for collaborative creation of a digital work. The type of the digital work is not limited herein, and the digital work generally refers to a digital work having structured information, and is collaboratively created through a plurality of creators.

The digital work collaborative creation method in this embodiment mainly includes the following processes:

first, a template producer produces a task template, and the template is a basis for task release.

Then, a task releaser selects a template to release a to-be-collaborated task.

Afterwards, collaborative creators create the released to-be-collaborated task. The digital work is generated according to creation content information.

It needs to be noted that, the aforementioned template producer, task releaser, and collaborative creators (abbreviated as “creators”) are just respective user roles in the digital work collaborative creation process, wherein the template producer is a user role that produces a task template, the task releaser is a user role that releases a collaborative creation task, and the collaborative creators are user roles that make created contents for the released collaborative creation task. The template producer, task releaser, and collaborative creators may include, but not limited to, at least one of a human individual user, a group entity user, an AI user, and a machine intelligence user, which is not limited by the embodiments of the present disclosure. In implementation, either a human individual, a group entity, or an AI software, an AI platform, an AI system, can equally be registered as a user of the collaborative creation system according to a unified mechanism, so as to participate in the collaborative creation process by being one of the above user roles. In some embodiments, an AI user or a machine intelligence user such as an AI software, an AI platform or an AI system may be provided with a dedicated user account according to a special registration mechanism, so as to participate in the collaborative creation process by being one of the above user roles. Hereinafter, the illustrated embodiments take the case of a human individual user participating in the collaborative creation as an example, and within the inventive concept thereof, the cases of a group entity user, an AI user, or a machine intelligence user participating in the collaborative creation can be directly derived without expenditure of creative efforts.

A process of producing the task template is as follows, including:

S001, the task template is produced. The specific process is as follows:

step B1: the template producer inputs template description information through a user terminal according to collaborative creation task requirements of the digital work, wherein the template description information is configured to describe functions of the task template, and/or a task setting method. The template description information may be a name of the template or a label of the template. A form of the template description information is not limited, and any information that describes the template belongs to the template description information. For example, for a patent value evaluation report template, the template description information input by the user is “This is a task template for collaborative creation of a patent value evaluation report. To set the task, the task releaser may input a patent application number, or a patent publication number, or a patent authorization number of a to-be-evaluated patent.” The template producer further creates a task setting object. At a task release phase, the task setting object is configured for the task releaser to input task setting information.

Step B2: the template producer divides the digital work collaborative creation task into a plurality of subtasks, inputs subtask description information, and sets a dependency relationship among the subtasks. The subtasks are configured to be provided to a creator for the creator to input created information according to the subtask description information; and the dependency relationship among the subtasks is configured for setting creation states of the subtasks.

Step B3: the template producer creates a creation content block, including a creation content block object. The template producer sets a content block display attribute and a content block relationship attribute for the creation content block.

The content block display attribute is configured to describe a display form of a content of the content block object in the digital work.

For example, for a document-class digital work, the content block display attribute includes setting information such as a font, character encoding, and a text color. For a file based on compound information, the content block display attribute includes a width and height of an image and a palette, a line type, a fill color, a size, an area in a vector graphic, a volume and a tone color of audio, etc.

The content block display attribute of the creation content block may be set by a task template maker at a stage of making the task template. If the template is not set or is set but is set to be changeable, the setting may also be made by the task releaser by inputting the task setting information. If the template is not set or is set but is set to be changeable, and the task setting information is not set or is set but is changeable, the setting may also be made by a creator of a corresponding subtask execution content by inputting creation content information. For example, in a task template of the patent value evaluation report, the content block display attribute of the creation content block is set by the task template maker at the stage of making the task template, and is set to be unchangeable.

The content block relationship attribute is configured to describe a mutual relationship between the content block object and other content block objects in the digital work.

For example, for the document-class digital work, the content block relationship attribute includes document location information such as a chapter, a paragraph, and an entry in a form. For the file based on the compound information, the content block relationship attribute includes information such as a spatial location, a time sequence, and a display hierarchy. For an audio digital work, the content block relationship attribute may be a relative location identifier or an absolute location identifier of an audio content in the work.

The content block relationship attribute of the creation content block may be set by the task template maker at the stage of making the task template. If the template is not set or is set but is set to be changeable, the setting may also be made by the task releaser by inputting the task setting information. If the template is not set or is set but is set to be changeable, and the task setting information is not set or is set but is changeable, the setting may also be made by a creator of a corresponding subtask execution content by inputting creation content information. For example, in the task template of the patent value evaluation report, the content block relationship attribute of the creation content block is set by the task template maker at the stage of making the task template, and is set to be unchangeable. The content block relationship attribute of the content block may be set by the task template maker at the stage of making the task template. If the template is not set or is set but is set to be changeable, the setting may also be made by the task releaser by inputting the task setting information.

Step B4: the template producer creates a first content generation manner, and the first content generation manner is configured to describe a manner of generating the creation content block from execution contents of the subtasks. The first content generation manner includes an information processing manner used by content generation, indicating that the creation content block is generated by the subtask execution contents through the information processing manner. The information processing manner used by the content generation may be direct copying, or search, or translation, or multimedia signal transformation, etc., and is specifically implemented by a script function, such as a python script, and a javascript.

Step B5: the template producer creates a default content block for providing some default information related to the content of the work.

Step B6: the template producer creates a setting content block, including a setting content block object. A content block display attribute and a content block relationship attribute are set for the setting content block. The first content generation manner for generating the creation content block from the execution contents of the subtasks is added. An information processing manner used by the content generation manner may be direct copying, or search, or translation, or multimedia signal transformation, etc., and is specifically implemented by the script function, such as the python script, and the javascript. Some task templates have the setting content block. For example, in a task template for a collaborative creation task of the patent value evaluation report, a content of the content block object of the setting content block will be generated from task setting information at a task release phase. The task setting information is input by the task releaser at the task release stage, and may specifically be information that can uniquely specify the to-be-evaluated patent, such as an application number or a publication number of the to-be-evaluated patent. Some task templates may not have the setting content block.

Step B7: a user terminal or a server generates a task template content, which at least includes the template description information, the task setting object, the plurality of subtasks and the dependency relationship thereof, the creation content block of the digital work, and the first content generation manner.

S002, the task template is released. The specific process is as follows:

After completing the task template producing process described in S001, the user can release the task template, which specifically includes the following steps:

step M1: the user terminal or the server generates a globally unique task template identifier a (m) for a current task template, which specifically may be a character string or a binary code string.

Step M2: a task template data block is generated. The task template data block includes the following contents: a task template content, a task template identifier and task template maker identity information (such as a user public key).

Step M3: a digital fingerprint of the task template data block is generated according to the task template data block. Specifically, it may be a digital fingerprint generated by using a private key by the user to digitally sign the task template data block.

Step M4: the server stores the task template data block and generates an access address of the task template data block.

Step M5: the user terminal or the server generates a task template data packet, including the following contents: the access address of the task template data block, the digital fingerprint of the task template data block, and a public key of the task template maker.

Step M6: the user terminal or the server releases the task data packet into a blockchain, to obtain a corresponding blockchain access address as a task template data packet index.

According to the task template, some tasks do not have a default content block, and therefore do not have a default draft. For a task template having a default content block, when the user terminal or the server receives a request from the user for viewing a digital work default draft, the task template is obtained, and the digital work default draft is generated according to the task template. The specific steps are as follows:

the server or the user terminal retrieves the default content block from the task template.

According to the content block display attribute and the content block relationship attribute of each default content block, the work contents of all the default content block objects are assembled to generate a default draft of the digital work.

The user terminal presents the default draft of the digital work.

After the above task template is produced, the task template releaser stores the task template into a task template library. The task template library includes various types of task templates for many industries.

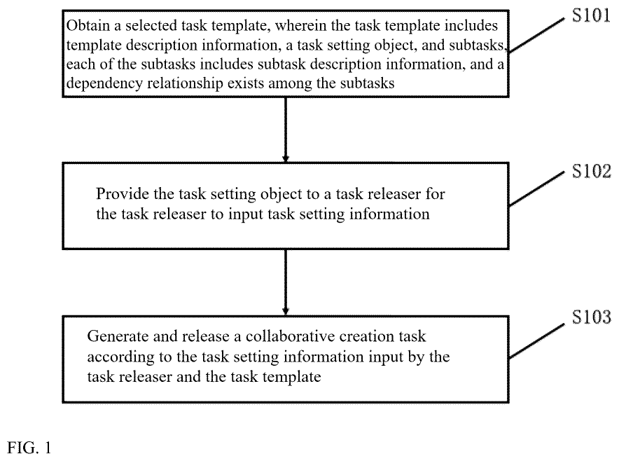

In the digital work collaborative creation process, the task releaser further needs to release the collaborative creation task, and therefore, a method for releasing a digital work collaborative creation task is provided in this implementation. The release method is applicable to a background server side, an execution subject may be an apparatus for releasing a digital work collaborative creation task, and the apparatus may be implemented as part or all of a computer device through software, hardware, or a manner of combining software and hardware, wherein the computer device may be a server or a terminal. The server in the embodiment of the present application May be a single server or a server cluster composed of a plurality of servers. The terminal in the embodiment of the present application may be other intelligent hardware devices such as a smartphone, a personal computer, a tablet, a wearable device, and an intelligent robot. A task releaser accesses the server side through client sides on the intelligent hardware devices such as the smartphone, the tablet, a computer, and a dedicated handheld terminal to carry out task release 12 activities. In this embodiment, a computer device is taken as an example. As shown in FIG. 1, the method for releasing the digital work collaborative creation task includes:

S101, a selected task template is obtained, wherein the task template includes template description information, a task setting object, and subtasks, each of the subtasks includes subtask description information, and a dependency relationship exists among the subtasks.

The task releaser selects the task template from a task template library. The template description information is configured to describe the task template; the task setting object is configured for the task releaser to input task setting information; the subtasks include the subtask description information, and the dependency relationship exists among the subtasks; the subtasks are configured to be provided to a creator for the creator to input created information according to the subtask description information; and the dependency relationship among the subtasks is configured for setting the creation states of the subtasks.

The task template further includes a creation content block of a digital work and a first content generation manner, wherein the creation content block of the digital work includes a content block object, a content block display attribute, and a content block relationship attribute; the content block object is configured for inputting a work content; the content block display attribute is configured to describe a display form of the work content of the content block object in the digital work; the content block relationship attribute is configured to describe a mutual relationship between the content block and other content blocks in the digital work; and the first content generation manner is configured to describe a manner of generating the creation content block from an execution content of the subtask.

This part has been introduced in detail in the above task template part, and is not repeated herein again.

S102, the task setting object is provided to the task releaser for the task releaser to input the task setting information.

The task setting information is configured to be provided to the creator for the creator to input the created information according to the task setting information and the subtask description information. For example, for a patent evaluation task, the input task setting information may be an application number of a to-be-evaluated patent.

S103, a collaborative creation task is generated and released according to the task setting information input by the task releaser and the task template.

In a task release process, a task state graph is formed according to the subtasks and the dependency relationship existing among the subtasks, and a template is released in a form of the task state graph, which is more intuitive. Nodes of the task state graph include the subtasks, and a relationship among the nodes includes the dependency relationship among the subtasks. The method for releasing the digital work collaborative creation task in this embodiment is adopted for task release, and the released task may be created by using the digital work collaborative creation method in the above embodiment.

In a specific task release process, it includes the following processes:

step D1: the user browses a digital work collaborative creation task template library in the server and selects a task template a(m) from it.

Step D2: the user terminal displays the task template a(m).

Step D3: the user inputs task setting information according to the template description information.

Step D4: the user terminal or the server generates a collaborative creation task content, which at least includes the task setting information and the task template.

Step D5: a globally unique task identifier Task_ID (n) is generated for the collaborative creation task. The task identifier may be specifically a character string or a binary code string.

Step D6: a task data block for the digital work collaborative creation is generated. The task data block includes the following contents: a task identifier Task_ID (n), a task content, and task releaser identity information (which may be specifically a user public key).

Step D7: a digital fingerprint of the task data block is generated according to the task data block. Specifically, it may be a digital fingerprint generated by using a private key by the user to digitally sign the task data block.

Step D8: the server stores the task data block and generates an access address of the task data block.

Step D9: a task data packet is generated and includes the following contents: the access address of the task data block, the digital fingerprint of the task data block, and a public key of the task releaser.

Step D10: the user terminal or the server releases the task data packet into a blockchain, to obtain a corresponding access address tokenURI as a task data packet index.

After the task releaser releases the task, collaborative creators may create the task. The digital work collaborative creation method provided in this implementation may be implemented through digital work collaborative creation software. The digital work collaborative creation software includes a server side and a client side. The digital work collaborative creation method is used on the server side, its execution subject may be a digital work collaborative creation apparatus, and the apparatus may be implemented as part or all of a computer device through software, hardware, or a manner of combining software and hardware, wherein the computer device may be a server or a terminal. The server in the embodiment of the present application may be a single server or a server cluster composed of a plurality of servers. The terminal in the embodiment of the present application may be other intelligent hardware devices such as a smartphone, a personal computer, a tablet, a wearable device, and an intelligent robot. The collaborative creators access the server side through client sides on the intelligent hardware devices such as the smartphone, the tablet, a computer, and a dedicated handheld terminal to carry out collaborative creation activities. In the following method embodiments, illustration is made by taking an example that the execution subject is the computer device.

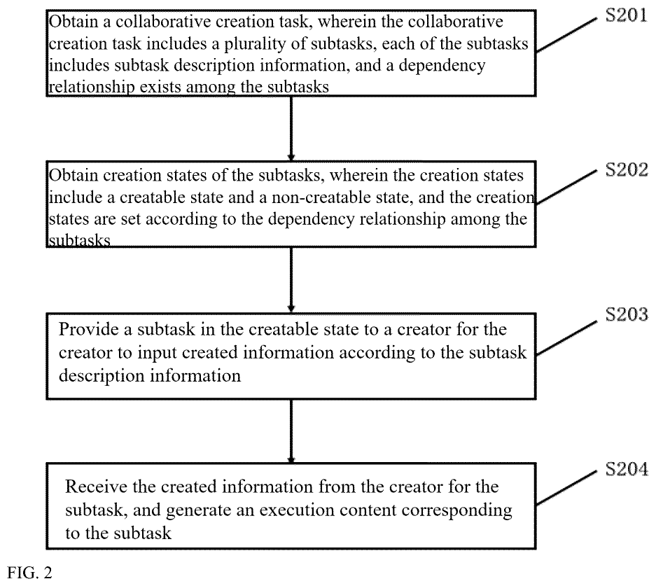

As shown in FIG. 2, the digital work collaborative creation method includes:

S201, a collaborative creation task is obtained, wherein the collaborative creation task includes a plurality of subtasks, each of the subtasks includes subtask description information, and a dependency relationship exists among the subtasks.

The collaborative creation task may be patent evaluation, industry analysis, industry research, technology evaluation, metaverse virtual park construction and other creation tasks. The created digital works are respectively corresponding to a patent evaluation report, an industry analysis report, an industry research report, a technology evaluation report, a metaverse virtual park and other digital works.

The collaborative creation task includes the plurality of subtasks, and the subtasks refer to tasks with finer granularity for creators to create and obtained after decomposing the collaborative creation task. For example, when the collaborative creation task is patent evaluation, the patent evaluation may be decomposed into six subtasks in total: keywords and search strategy, relevant comparative literature, technical value evaluation, legal value evaluation, market value evaluation, and evaluation conclusions. Each subtask is created by a creator skilled in the relevant professional field.

Each of the subtasks includes subtask description information, and the subtask description information is information for describing the subtask. For example, the subtask description information may be a name of the subtask or a label of the subtask. A form of the subtask description information is not limited, and any information that describes the subtask belongs to the subtask description information. For example, taking patent evaluation as an example, in a subtask such as keywords and search strategy included in the patent evaluation, a title “keywords and search strategy” of the subtask is configured to describe the subtask, and therefore also belongs to the subtask description information.

The subtasks do not exist in isolation. If the subtasks are isolated, the responsible person of each subtask may create the subtask separately after the subtasks are subcontracted. In this embodiment, the dependency relationship exists among at least part of the subtasks among the plurality of subtasks decomposed from the collaborative creation task. The dependency relationship here refers to the fact that the creation of a subsequent subtask needs to be performed on the basis of the creation of a preceding subtask, and the creation of the subsequent subtask depends on a creation content of the preceding subtask. For example, the subtask “keywords and search strategy” included by the patent evaluation is the basis for the subtask “relevant comparative literature”. The subtask “relevant comparative literature” is performed on the basis of the subtask “keywords and search strategy”, which means that only when the keywords and search strategy are determined, the creation of the “relevant comparative literature” can be performed according to search situations of the keywords and search strategy. The dependency relationship existing among the subtasks refers to this dependency relationship in terms of creation.

When obtaining the collaborative creation task, the collaborative creation task includes a task template and task setting information. For the task template, reference may be made to the foregoing part, and details will not be repeated here again. The task setting information is configured to be provided to the creator for the creator to input created information according to the task setting information and the subtask description information.

In a further implementation, in order to make in intuitive representation of the collaborative creation task, a first task state graph is formed according to the subtasks and the dependency relationship existing among the subtasks, nodes of the first task state graph include the subtasks, and a relationship among the nodes includes the dependency relationship among the subtasks.

In addition, when obtaining the collaborative creation task, a collaborative creation task identifier may generally also be obtained. The collaborative creation task identifier is a globally unique identifier generated when the collaborative creation task is released, and the task identifier uniquely corresponds to the collaborative creation task and does not cause data confusion when contents of the collaborative creation task are the same.

S202, creation states of the subtasks are obtained, wherein the creation states include a creatable state and a non-creatable state, and the creation states are set according to the dependency relationship among the subtasks.

Due to the dependency relationship existing among the subtasks, there is also a creation opportunity for whether the subtasks may be created. In this embodiment, the creation states of the subtasks are set. The creation states of the subtasks are divided into a creatable state and a non-creatable state. For a specific creator, one task has only one creation state at a specific moment, either the creatable state or the non-creatable state. The creation states of the subtasks are also dynamic, and when a creation condition is met, the subtasks may be updated from the non-creatable state to the creatable state.

The creation states are set according to the dependency relationship among the subtasks. For a subtask that does not depend on other subtasks for creation, its initial state is the creatable state. For a subtask that depends on other subtasks for creation, when the subtasks on which this subtask depends are created, this subtask may be set to be in the creatable state.

Specifically, for example, in the subtask of patent evaluation, before the “keywords and search strategy” are created, the “relevant comparative literature” is in a non-creatable state; and after the “keywords and search strategy” are created, the “relevant comparative literature” is in a creatable state.

S203, a subtask in the creatable state is provided to the creator for the creator to input created information according to the subtask description information.

The creator may create the subtask in the creatable state. In response to a creation request of the creator, a system background provides the subtask in the creatable state to the creator. There may be one or more subtasks in the creatable state that can be displayed to the creator for selection. The creator inputs the created information according to description of the subtask description information for the subtask. For example, in a patent evaluation task, the creator creates the subtask according to a prompt of the subtask description information of the “keywords and search strategy”.

S204, the created information is received from the creator for the subtask, and an execution content corresponding to the subtask is generated.

After the creator creates the subtask, a system receives the created information from the creator for the subtask. For example, for the subtask of “keywords and search strategy”, the creator inputs the keywords and search strategy that the creator deems appropriate. After the creator inputs information, the system background generates the execution content corresponding to this subtask according to the created information of the creator. The execution content refers to an information content formed by the creator after creating the subtask. Based on the execution content created by each subtask, a digital work can be assembled to achieve collaborative creation of the digital work.

The digital work collaborative creation method in this embodiment decomposes the collaborative creation task into the plurality of subtasks having the dependency relationship and including the subtask description information, so that the task to be collaboratively created may be divided into subtasks which have finer granularity and the dependency relationship for the creator to create. In the collaborative creation process, the creation states of the subtasks are set according to the dependency relationship among the subtasks, a reasonable order of creation for the subtasks is ensured, the created information has higher accuracy, and creation activities are more efficient. The subtask in the creatable state is provided to the creator for the creator to input the created information according to the subtask description information, the created information from the creator for the subtasks is received, and the execution content of the subtasks is generated. Through this implementation plan, collaborative creation of the digital work is achieved, and an effective bridge is built between task requirements and creators. After the task is released, creators who are good at these subtasks having finer granularity may create according to the creation states to ensure that tasks are created in a correct order and on the basis of consummate basic information so as to form the digital work, thereby providing a more effective mode for the collaborative creation of the tasks. The defects in the prior art that the creation methods for the digital work carry high collaborative costs, are complex to manage, and do not allow for the full exertion of the professional expertise of professionals are overcome, and a novel collaborative creation mode is provided.

As a further implementation, on the basis of the above implementation, the subtasks May be divided into an atomic-type subtask and a framework-type subtask according to different situations of the subtasks. Creation content information of the atomic-type subtask does not include a next-level subtask, and the creator may directly create the content of the subtask and complete the subtask creation. Creation content information of the framework-type subtask includes one or more next-level subtasks, and the creator needs to create the next-level subtask first.

For example, in the collaborative creation task of the patent value evaluation report above, the patent evaluation is decomposed into the following subtasks: keywords and search strategy, relevant comparative literature, technical value evaluation, legal value evaluation, market value evaluation, and evaluation conclusions. The contents of these subtasks do not include the next-level subtask, and the creator may create the content of the subtasks according to the creation states. Therefore, the above subtasks belong to the atomic-type subtask.

In a collaborative creation task of building a metaverse theme park, there are framework-type subtasks, and the framework-type subtasks may include a plurality of next-level subtasks. The next-level subtasks and their mutual dependency relationships may form a directed acyclic graph.

There is a difference between the framework-type subtask and the atomic-type subtask; one framework-type subtask internally has a framework set of the next-level subtask consisting of a plurality of next-level subtasks and their mutual dependency relationships. The framework set of the next-level subtask in one framework-type subtask may be created, and the framework set of the next-level subtask is generated according to the creation of the creator. The number and type of the framework set of the next-level subtask are determined by the creator. The next-level subtask May also be an atomic-type or a framework-type.

For ease of understanding, the atomic-type subtask and the framework-type subtask are introduced separately here.

For the atomic-type subtask, the execution content of the subtask generated according to the information created by the creator may include the following information:
(1) creation content information, including content information input by the creator for the subtask. The content information here mainly refers to information related to the content of the subtask input by the creator. For example, in the subtask of “keywords and search strategy”, the specific keywords and search formulas input by the creator belong to the content information.
(2) Creator identity information, generated based on the creator. In order to better identify the creator and facilitate subsequent rights distribution, the identity of the creator needs to be confirmed. A manner for confirming the creator identity information here is not specifically limited, and the creator identity information may be a user identifier, an ID, or account information logged by the creator, or a user public key, associated fields that may identify user information, and so on. In some embodiments, if the creator is an AI user or machine intelligence user, a dedicated account may be provided for the AI user or machine intelligence user, wherein the identity information of the AI user or machine intelligence user may be information of name, version number and the like of the corresponding software/platform/system.
(3) Content relationship information, including:
   a content attribution relationship, being an attribution relationship between the execution content of the subtask and the subtask, wherein the attribution relationship is configured to indicate that the subtask has the execution content.

It may be understood that each time a user creates one subtask, the execution content of the subtask created by the user must correspond to this subtask. To uniformly describe this correspondence, it is expressed as that: the execution content of the subtask belongs to the subtask, and the subtask has the execution content.

When the subtask is created for multiple times, one subtask may have the plurality of execution contents, these execution contents may be created by the plurality of creators respectively, or created by one creator to create one subtask for multiple times respectively.

For the subtasks with the dependency relationship, when a subtask A depends on a subtask B, an execution content a1 belongs to the subtask A, an execution content b1 belongs to the subtask B, and the creator creates the subtask A based on the execution content b1 owned by the subtask B, so as to obtain the execution content a1. In this case, the content relationship 8 information of the execution content a1 further includes:
a content dependency relationship, pointing to the execution content b1 owned by the subtask B, indicating that the execution content a1 depends on the execution content b1, that is, the execution content a1 is derived from the execution content b1. The situation of “derivation” refers to the situation that the subtask A depends on the subtask B, after selecting the execution content b1 of the subtask B, the creator creates the subtask A to obtain the execution content a1. In this case, it can be deemed that the execution content a1 of the subtask A is derived from the execution content b1 of the subtask B.

The above content dependency relationship describes a created prerequisite relationship between the execution contents of the subtasks that have the dependency relationship, so that when the subtasks have the plurality of execution contents, the prerequisite and foundation corresponding to each execution content can also be clearly expressed, thereby laying a foundation for forming a complete digital work according to a creation process of the creator.

In addition to the above content dependency relationship, the execution content May further include a content inheritance relationship, which is configured to indicate revision and update of the execution content. If the execution content a1 of the subtask A is revised by the creator based on a1 to form a2, then the execution content of a2 further includes the content inheritance relationship, pointing to a1, and indicating that a2 is obtained by revising on the basis of a1. Through the inheritance relationship, iterative modifications of the subtasks may be better recorded, thereby facilitating subsequent rights confirmation and allocation, a2 and a1 may be the same creator or different creators.

For the framework-type subtask, such as a collaborative creation task in a metaverse theme park, including a subtask of an “individual building” and a subtask of a “park zoning landscape”, the two subtasks are both the framework-type subtask, and the execution contents of the subtasks include:
(1) creation content information, including content information input by the creator for the subtask.
(1.1) A setting object of the execution content of the subtask is provided to an execution content creator for the execution content creator to input execution content setting information.
(1.2) The creation content information further includes next-level subtasks, including next-level subtask description information configured to be provided to the creator for the creator to input the created information according to the next-level subtask description information.

For example, the collaborative creation task in the metaverse theme park includes the subtask of the “individual building” and the subtask of the “park zoning landscape”, and the two subtasks are both the framework-type subtask. The next-level subtasks included by the subtask of “individual building” include three next-level subtasks such as “individual building planning”, a “building framework”, and “indoor and outdoor decoration”.
(1.3) An attribution relationship between the next-level subtasks and the execution content of the subtask is configured to indicate that the execution content of the subtask owns the next-level subtasks.

Corresponding to the collaborative creation task of the metaverse theme park above, the three next-level subtasks of the “individual building planning”, the “building framework”, and the “indoor and outdoor decoration” belong to the subtask of the “individual building”. That is to say, the subtask of the “individual building” has the three next-level subtasks of the “individual building planning”, the “building framework”, and the “indoor and outdoor decoration”.
(1.4) A dependency relationship among the next-level subtasks is configured for setting the creation states of the next-level subtasks.

If there are the plurality of next-level subtasks, the dependency relationship may exist among the plurality of next-level subtasks, and the dependency relationship is the same as the above introduction and will not be repeated. Certainly, the plurality of next-level subtasks may also be independent of each other and have no dependency relationship. Due to the fact that the next-level subtask in the framework-type subtask may be one or more, the above dependency relationship may exist. When there is only one next-level subtask or there is no dependency relationship among the next-level subtasks, the above dependency relationship may also not exist.
(1.5) A dependency relationship between the next-level subtask and execution contents of other subtasks points to the execution contents of other subtasks on which the execution content of the subtask depends. For example, it is a dependency relationship between the next-level subtask of “individual building planning” and “overall construction planning”.
(1.6) A dependency relationship between other subtasks and the next-level subtask points to the next-level subtask. For example, it is a dependency relationship between a subtask of “park acousto-optic design” and the next-level subtask of “building framework”.

The above content may also be set in a template of the execution content of the framework-type subtask.
(2) Creator identity information, generated based on the creator. The creator identify information is similar to that of the atomic-type subtask and will not be repeated here.
(3) Content relationship information, including
(3.1) a content attribution relationship, being an attribution relationship between the execution content of the subtask and the subtask, and being the same as that of the atomic-type subtask.
(3.2) A content dependency relationship, pointing to a pre-execution content from which the execution content of the subtask is derived, and being the same as that of the atomic-type subtask.
(3.3) A content inheritance relationship, being the same as that of the atomic-type subtask.

In this implementation, the execution contents of the atomic-type subtask and the framework-type subtask are introduced respectively. By limiting the creation content information, the creator identity information, the content relationship information, etc. included in the execution contents of the atomic-type subtask and the framework-type subtask, the internal composition and interconnection of these two different types of subtasks can be clearly expressed, thereby providing a basis for collaborative creation of the task.

In addition, for each creation of the creator, when the execution content corresponding to the subtask is generated, a second task state graph is further generated, wherein nodes of the second task state graph include subtask nodes and execution content nodes, the subtask nodes include the subtasks, the execution content nodes include the execution contents of the subtasks, and a relationship among the nodes includes the dependency relationship among the subtasks, the content attribution relationship between the execution contents and the subtasks, and/or the content dependency relationship between the execution contents, and/or the content inheritance relationship between the execution contents.

For different types of subtasks, there may be some differences in the process of setting the creation states according to the dependency relationship among the subtasks. In this implementation, how to set the creation states of the subtasks will be illustrated.

When setting the creation states of the subtasks, a subtask that does not depend on any other subtask and is able to be directly created is set to be in a creatable state. For example, in the patent evaluation task, “keywords and search strategy” do not depend on other subtasks and are initially set to be in the creatable state.

A subtask that is only able to be created by depending on one or more other subtasks is set to be in the creatable state when all atomic-type subtasks on which this subtask depends have execution contents; and this subtask is set to be in a non-creatable state when one of the atomic-type subtasks on which this subtask depends does not have an execution content. For example, after the “keywords and search strategy” are created, the “relevant comparative literature” is in the creatable state. If one of the “technical value evaluation”, “legal value evaluation”, or “market value evaluation” is in a non-creatable state, the “evaluation conclusions” are in the non-creatable state.

When the atomic-type subtask on which the subtask depends has a plurality of execution contents, the step of setting the subtask to be in the creatable state includes:
receiving one execution content selected by the creator from the plurality of execution contents; and
setting the subtask to be in the creatable state.

That is to say, when the subtask A depends on the subtask B and the subtask B has a plurality of creation versions, the creator needs to select one execution content (i.e., one creation version) of the subtask B before the subtask A is set to in the creatable state, and the creator May create the subtask A. Certainly, the creator may also create the subtask A first, and then after the creation is completed, the creator selects a certain version of the subtask B on which the creator is based. At this time, it is also possible to select one of the execution contents of the subtask B.

In addition, if a first subtask is the framework-type subtask and a second subtask depends only on the first subtask, the step of setting the creation states according to the dependency relationship among the subtasks includes:
setting the second subtask to be in the creatable state when the first subtask has no executable content, or the executable content owned by the first subtask is not selected by the creator.

The execution content in the first subtask selected by the creator is received when the first subtask has the execution content.

The second subtask is set to be in the creatable state when atomic-type next-level subtasks owned by the selected execution content all have execution contents.

In this case, for a subtask that depends only on one framework-type subtask, the creation state of the subtask is determined according to the framework-type subtask. After all the contents required to be created in the first subtask selected by the creator are created and selected, the second subtask may be created.

In another case, when the first subtask is the framework-type subtask and the second subtask depends on the first subtask and one or more other atomic-type subtasks, the step of setting the creation states according to the dependency relationship among the subtasks includes:

if the creator does not select the subtask execution content in the first subtask,
the second subtask is set to be in the creatable state when all the atomic-type subtasks on which the subtask depends have execution contents; and the second subtask is set to be in the non-creatable state when one of the atomic-type subtasks on which the subtask depends does not have an execution content.

If the creator selects one or more subtask execution contents in the first subtask,
the second subtask is set to be in the creatable state when atomic-type next-level subtasks owned by the one or more selected execution contents all have execution contents and all atomic-type subtasks on which the subtask depends have execution contents; and the second subtask is set to be in the non-creatable state when one of the atomic-type next-level subtasks owned by the one or more selected execution contents does not have an execution content, or one of the atomic-type subtasks on which the subtask depends does not have an execution content.

According to the above manner, the creation states are set to ensure that the basis for subsequent creations is uniquely determined. In this way, the subsequent creations and the selected creation can form a unified premise, ensuring the effectiveness of collaborative creation and making the final digital work reasonable.

The created information and the creation process may be presented in a graphical way through the task state graph, making it easier for the creator to intuitively obtain relevant information. The step of providing the subtask in the creatable state to the creator for the creator to input the created information according to the subtask description information includes:
first, the first task state graph or the second task state graph is displayed, wherein the first task state graph and the second task state graph have been introduced above, and will not be repeated here.

A subtask in the creatable state is set to a mode in which the subtask is displayed in a first manner and is able to be selected for creation by the creator. The first manner here may be to represent by using a certain color, or shapes such as a box or a round frame, or special symbol annotation, or a graphic with a certain size.

A subtask in the non-creatable state is set to a mode in which the subtask is displayed in a second manner and is unable to be selected for creation by the creator, wherein the second manner is different from the first manner.

The subtasks in the creatable state and the non-creatable state are respectively represented in different ways, such as different colors, different fonts, different block diagram shapes, different symbol annotations, and setting of different sizes. Display manners are not limited, and through the different display manners, the creator can clearly know which one can be created and which one needs to wait, making it intuitive and convenient.

When the creator is an AI user or machine intelligence user, the first task state graph or the second task state graph may be directly pushed to the computer/server where the AI user or machine intelligence user resides in, with the creation states therein being set according to the associated fields.

As a further implementation, in order to better store the execution contents of the subtasks created by the creator on a blockchain, the digital work collaborative creation method, based on the above, further includes: generating an execution content data block, wherein the execution content data block includes creation content information, content relationship information, and/or a task identifier, and/or creator identity information; and the content relationship information includes the content attribution relationship, and/or the content dependency relationship, and/or the content inheritance relationship. The manner of generating the execution content data block is not limited here and may be in a form of a package or other files.

The execution content data block is stored, an access address of the execution content data block is generated, an execution content data packet is generated, and the execution content data packet is released into a blockchain. The execution content data packet includes the access address of the execution content data block, and/or a digital fingerprint of the execution content data block generated according to the execution content data block.

Through the above manner, it is possible to store the execution content created by the creator on the blockchain, which has the characteristics of security, tamper proofness, and non-repudiation, thereby providing basic conditions for authentic right and rights distribution of subsequent creation.

For digital works during creation or the created digital work, information snapshots May further be generated to display intermediate draft works or complete draft works. The information snapshots may be generated by the user according to his/her needs.

The creation content information of the framework-type subtask includes next-level subtasks, and the creation content information of the atomic-type subtask does not include next-level subtasks. A digital work information snapshot is generated when an execution content node of the atomic-type subtask exists in the second task state graph, or when the execution content node of the atomic-type subtask and an execution content node of a next-level atomic-type subtask both exist in the second task state graph, or when the execution content node of the next-level atomic-type subtask exists in the second task state graph. The digital work information snapshot includes the execution content node, as well as the content dependency relationship among the execution content nodes. If the content dependency relationship has not been generated yet, it may not include the content dependency relationship.

A digital work draft is generated according to the execution content and includes a digital work intermediate draft and a digital work complete draft.

When there are multiple versions of the complete draft, the task releaser may select one or several versions as a final draft of the digital work.

In the above digital work collaborative creation method, continuous creation of the digital work may be performed by multiple people, a novel production relationship is established, and the comparative advantage of each creator is exerted. In a refined social division of labor environment of the information age, a more efficient and convenient collaborative creation method with multi-creator collaboration and exerting group advantages is provided.

On the basis of the above implementations, it may also include a process of viewing the digital work intermediate draft, with the specific process as follows:

when at least one atomic-type subtask in the second task state graph of the collaborative creation task has the execution content, the user terminal or the server can respond to a user's request to generate the digital work intermediate draft according to an intermediate draft information snapshot, the task template, and the task setting information (optional). The specific steps are as follows:
the user terminal or the server receives the user's request to view the digital work intermediate draft, obtains the task template, and obtains the task setting information of the digital work collaborative creation task.

An intermediate draft information snapshot of the digital work viewed by the user is obtained so as to extract the execution content from it. When making the request to view the digital work intermediate draft, the user needs to first select the intermediate draft information snapshot he/she desires to view. The intermediate draft information snapshot includes the execution content nodes in the second task state graph, and the content dependency relationship exists among the execution content nodes respectively owned by subtask nodes having a dependency relationship. For the atomic-type subtask node that has the plurality of execution content nodes in the second task state graph, the user needs to select one execution content node from the plurality of execution content nodes as the node that the user desires to view.

A first content generation relationship between the creation content block and the task execution content is extracted from the task template. According to the first content generation relationship, the user terminal or the server performs information processing such as search, editing, and multimedia information transformation based on the executed content, and generates work contents of a series of creation content block objects.

If the task template contains a setting content block, a content generation relationship between the setting content block and the task setting information is extracted. According to the content generation relationship, the user terminal or the server performs information processing such as search, editing, and multimedia information transformation based on the task setting information, and generates work contents of a series of setting content block objects.

If the task template contains default content blocks, all the default content blocks are extracted.

According to the content block display attribute and the content block relationship attribute of each creation content block, each setting content block, and each default content block, the user terminal or the server assembles the work contents of the aforementioned content block objects to generate the intermediate draft of the digital work.

The user terminal presents the digital work intermediate draft.

On the basis of the above implementations, it may also include a process of viewing the digital work complete draft, with the specific process as follows:
when the atomic-type subtasks in the second task state graph of the collaborative creation task all have at least one execution content, and the atomic-type next-level subtasks owned in the selected execution content of the framework-type subtask all have at least one execution content, according to the user's viewing request, the user terminal or the server can generate a digital work complete draft based on a complete draft information snapshot, the task template, and the task setting information (optional). The specific steps are as follows:
the user terminal or the server receives the user's request to view the digital work complete draft, obtains the task template, and obtains the task setting information (optional) of the digital work collaborative creation task.

The complete draft information snapshot of the digital work viewed by the user is obtained so as to generate the digital work complete draft.

The user terminal presents the digital work complete draft.

In order to facilitate a better understanding of the present application, a complete embodiment is provided in the implementation of the present application by taking a collaborative creation task of a patent value evaluation report as an example. A digital work created by the collaborative creation task in this embodiment is the “Patent Value Evaluation Report”.

T1, Make and release a collaborative creation task template for the patent value evaluation report

A task template maker completes making of the task template. Afterwards, the task template is stored in a digital work collaborative creation task template library, a globally unique task template identifier a(m) (which may be a character string or a string of binary codes) is generated, and a task template access address is generated and released.

The collaborative creation task template of the patent value evaluation report includes template description information, a task setting object, subtasks, a default content block, a setting content block, a creation content block, a content generation manner for the setting content block, and a first content generation manner.

The template description information is that “this task template is configured for the collaborative creation task of the patent value evaluation report. To set the task, a task releaser May input a patent application number, or a patent publication number, or a patent authorization number of a to-be-evaluated patent.”

The task setting object is configured for the task releaser to input task setting information according to the template description information.

The subtasks include subtask description information, and a dependency relationship exists among the subtasks. As shown in the table below:

| | Subtask | |
|---|---|---|
| Subtask | description | |
| identifier | information | Subtask dependency relationship |
| Subtask(1) | Keywords and | Not depending on other subtasks |
| | search strategy | |
| Subtask(2) | Relevant | Depending on Subtask(1) |
| | comparative | |
| | literature | |
| Subtask(3) | Technical value | Depending on Subtask(2) |
| | evaluation | |
| Subtask(4) | Legal value | Depending on Subtask(2) |
| | evaluation | |
| Subtask(5) | Market value | Not depending on other subtasks |
| | evaluation | |
| Subtask(9) | Evaluation | Depending on Subtask(3), Subtask(4), |
| | conclusions | Subtask(5) |

The default content block includes work contents input by the template maker, such as a document title on a cover, a title of each level of chapter, a default text in each chapter and a chart frame.

| Default | | Content block | |
|---|---|---|---|
| content block | Work content of | relationship | |
| identifier | content block object | attribute | Content block display attribute |
| DCblock(1) | Patent value | Located on | The text and font sizes are size |
| | evaluation report | page 1 of the | two. |
| | | report, centered | The above settings cannot be |
| | | in the middle | changed. |
| DCblock(2) | Chapter 1 Basic Patent | Located on | The text and font sizes are size |
| | Information | page 2 of the | four. |
| | | report, top left | The above settings cannot be |
| | | justifying | changed. |
| DCblock(3) | Information table (22 | Located on the | Table. The content of the table |
| | table entries in total) | next line of | entries in the table is that the text |
| | | DCblock(2). | and font sizes are size five. |
| | | | The above settings cannot be |
| | | | changed. |
| DCblock(4) | Chapter 2 Main | Located on the | The text and font sizes are size |
| | Technical Information | next line of | four. |
| | | DCblock(3) | The above settings cannot be |
| | | | changed. |
| DCblock(5) | Section 2.1 Patent | Located on the | The text and font sizes are size |
| | Abstract | next line of | little four. |
| | | DCblock(4) | The above settings cannot be |
| | | | changed. |
| DCblock(6) | Section 2.2 Drawing | Located on the | The text and font sizes are size |
| | of the Abstract | next line of | little four. |
| | | SCblock(2) | The above settings cannot be |
| | | | changed. |
| DCblock(7) | Chapter 3 | Located on the | The text and font sizes are size |
| | Comparative | next line of | four. |
| | Literature | SCblock(3) | The above settings cannot be |
| | | | changed. |
| DCblock(8) | Section 3.1 Keywords | Located on the | The text and font sizes are size |
| | and Search Strategy | next line of | little four. |
| | | DCblock(7) | The above settings cannot be |
| | | | changed. |
| DCblock(9) | Section 3.2 Relevant | Located on the | The text and font sizes are size |
| | Comparative | next line of | little four. |
| | Literature | CCblock(1) | The above settings cannot be |
| | | | changed. |
| DCblock(10) | Chapter 4 Technical | Located on the | The text and font sizes are size |
| | Value Evaluation | next line of | four. |
| | | CCblock(2) | The above settings cannot be |
| | | | changed. |
| DCblock(11) | Chapter 5 Legal Value | Located on the | The text and font sizes are size |
| | Evaluation | next line of | four. |
| | | CCblock(3) | The above settings cannot be |
| | | | changed. |
| DCblock(12) | Chapter 6 Market | Located on the | The text and font sizes are size |
| | Value Evaluation | next line of | four. |
| | | CCblock(4) | The above settings cannot be |
| | | | changed. |
| DCblock(13) | Chapter 7 Evaluation | Located on the | The text and font sizes are size |
| | Conclusions | next line of | four. |
| | | CCblock(5) | The above settings cannot be |
| | | | changed. |

The setting content block includes the work contents generated by the task setting information that needs to be input by the task releaser in the relevant chapters.

| Setting content | Content block relationship | |
|---|---|---|
| block identifier | attribute | Content block display attribute |
| SCblock(1.1)-SC | Located in the 22 | The text and font sizes are size five. |
| block(1.22) | corresponding table entries | The above settings cannot be changed. |
| | of the default content block | |
| | DCblock (3) | |
| SCblock(2) | Located on the next line of | The text and font sizes are size five. |
| | the default content block | The above settings cannot be changed. |
| | DCblock(5) | |
| SCblock(3) | Located on the next line of | Image. According to the original drawing |
| | the default content block | size. |
| | DCblock(6) | The above settings cannot be changed. |

A content generation manner for the setting content block, which is configured to describe a manner for generating the setting content block from the task setting information, is as shown in the following table:

| Task setting | Setting content | |
|---|---|---|
| information | block identifier | Content generation manner |
| Information that | SCblock(1) | Patent information is extracted |
| can uniquely | | from the task setting |
| specify a patent: a | | information, and the work |
| patent application | | contents of the setting |
| number, a patent | | content block objects are |
| publication | | generated through search |
| number, and a | | and editing. |
| patent authorization | SCblock(2) | Patent information is extracted |
| number | | from the task setting |
| | | information, and the work |
| | | contents of the setting |
| | | content block objects are |
| | | generated through search |
| | | and editing. |
| | SCblock(3) | Patent information is extracted |
| | | from the task setting |
| | | information, and the work |
| | | contents of the setting |
| | | content block objects are |
| | | generated through search |
| | | and editing. |
| | | Patent information is extracted |

The creation content block includes the work content generated by the task execution content required to be created by collaborative creators in each chapter, as shown in the table below:

| Creation content | Content block relationship | |
|---|---|---|
| block identifier | attribute | Content block display attribute |
| CCblock(1) | Located on the next line | The text and font sizes are size five. |
| | behind the default content | The above settings can be changed by |
| | block DCblock(8) | the first content generation manner. |
| CCblock(2) | Located on the next line | The text and font sizes are size five. |
| | behind the default content | The above settings can be changed by |
| | block DCblock(9) | the first content generation manner. |
| CCblock(3) | Located on the next line | The text and font sizes are size five. |
| | behind the default content | The above settings can be changed by |
| | block DCblock(10) | the first content generation manner. |
| CCblock(4) | Located on the next line | The text and font sizes are size five. |
| | behind the default content | The above settings can be changed by |
| | block DCblock(11) | the first content generation manner. |
| CCblock(5) | Located on the next line | The text and font sizes are size five. |
| | behind the default content | The above settings can be changed by |
| | block DCblock(12) | the first content generation manner. |
| CCblock(6) | Located on the next line | The text and font sizes are size five. |
| | behind the default content | The above settings can be changed by |
| | block DCblock(13) | the first content generation manner. |

The first content generation manner, which is configured to describe a manner of generating the creation content block from the execution content of the subtask, is as shown in the following table:

| Subtask | Creation content | |
|---|---|---|
| identifier | block identifier | Content generation manner |
| Subtask(1) | CCblock(1) | The work content is extracted |
| | | from the creation content |
| | | information of the subtask |
| | | execution content, and the |
| | | work content that generates |
| | | the creation content block |
| | | object is copied. |
| Subtask(2) | CCblock(2) | The work content is extracted |
| | | from the creation content |
| | | information of the subtask |
| | | execution content, and the |
| | | work content that generates |
| | | the creation content block |
| | | object is copied. |
| Subtask(3) | CCblock(3) | The work content is extracted |
| | | from the creation content |
| | | information of the subtask |
| | | execution content, and the |
| | | work content that generates |
| | | the creation content block |
| | | object is copied. |
| Subtask(4) | CCblock(4) | The work content is extracted |
| | | from the creation content |
| | | information of the subtask |
| | | execution content, and the |
| | | work content that generates |
| | | the creation content block |
| | | object is copied. |
| Subtask(5) | CCblock(5) | The work content is extracted |
| | | from the creation content |
| | | information of the subtask |
| | | execution content, and the |
| | | work content that generates |
| | | the creation content block |
| | | object is copied. |
| Subtask(6) | CCblock(6) | The work content is extracted |
| | | from the creation content |
| | | information of the subtask |
| | | execution content, and the |
| | | work content that generates |
| | | the creation content block |
| | | object is copied. |

The patent value evaluation report belongs to the document-class digital work, and HTML is used as a collaborative creation task template format for this digital work.

T2, Set and release a collaborative creation task of the patent value evaluation report

step R1: a user A browses a digital work collaborative creation task template library in the server through the user terminal, and selects a collaborative creation task template a(m) of the “Patent Value Evaluation Report”.

Step R2: the user terminal displays a task template content.

Step R3: the user A inputs the task setting information, namely, the patent authorization number, through the user terminal.

Step R4: a collaborative creation task Task_ID (n) is generated and released according to the task setting information and the task template. Step R4 specifically includes the following steps:

R4.1: the user terminal or the server generates a globally unique collaborative creation task identifier Task_ID (n), which may specifically be a character string, for a current collaborative 14 creation task.

R4.2: the user A generates a digital work collaborative creation task data block through the user terminal, and the task data block includes the task identifier Task_ID (n), a task template identifier a(m), task setting information (patent authorization number), task releaser identity information (user A's public key), and other contents related to task initialization.

R4.3: a digital fingerprint of the task data block is generated according to the task data block, and may specifically be a digital fingerprint generated by using a private key by the user A to digitally sign the task data block.

R4.4: the user terminal or the server stores the task data block and generates an access address of the task data block.

R4.5: the user terminal or the server generates a task data packet, including the following contents: the access address of the task data block, the digital fingerprint of the task data block, and a public key of the task releaser.

R4.6: the user terminal or the server releases the task data packet into a blockchain to obtain a corresponding access address tokenURI as a task data packet index.

T3, Collaborative creation method of the patent value evaluation report

Step S1: the user a obtains the collaborative creation task Task_ID (n) from the server through the user terminal.

Step S2: the user a obtains the creation states of the subtasks through the user terminal.

Subtask (1) and Subtask (5) which do not depend on other subtasks and can be directly created are set to be in a creatable state.

The other subtasks are set to be in a non-creatable state.

The subtasks in the creatable state are marked with a symbol V and may be selected by the creator to input created information.

The subtasks in the non-creatable state are marked with a symbol x and cannot be selected by the creator to input the created information.

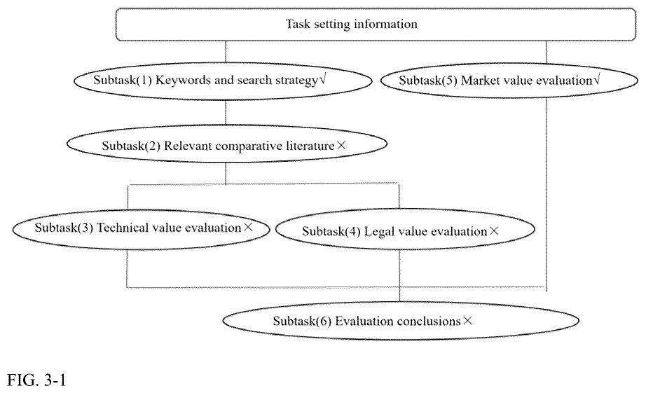

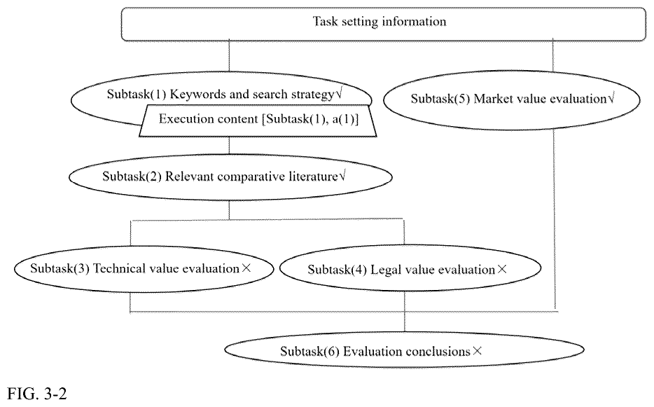

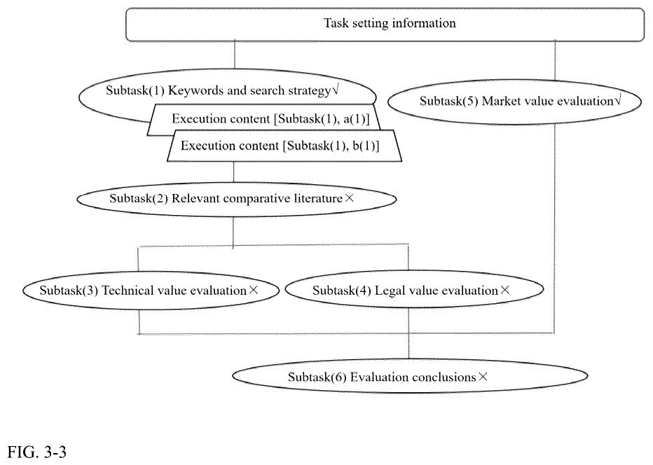

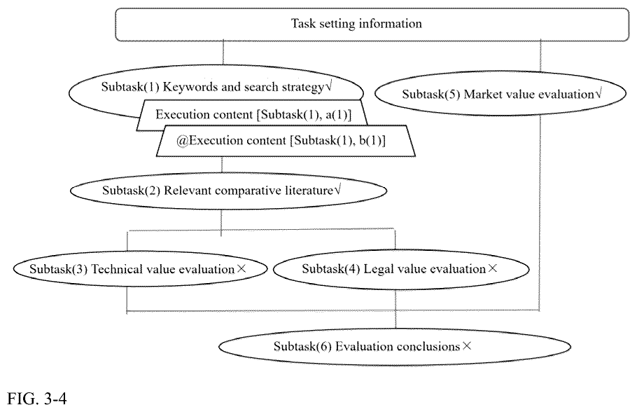

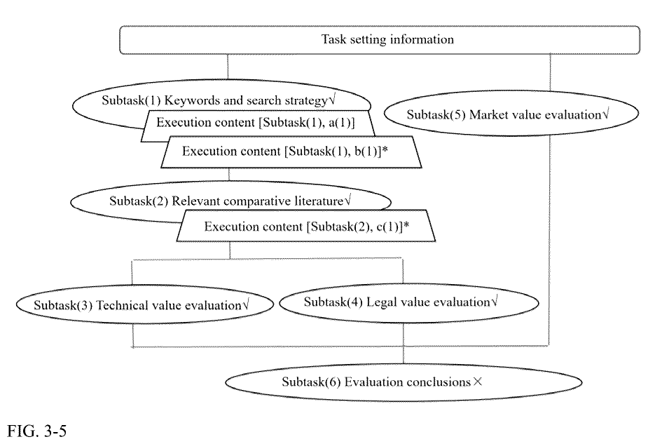

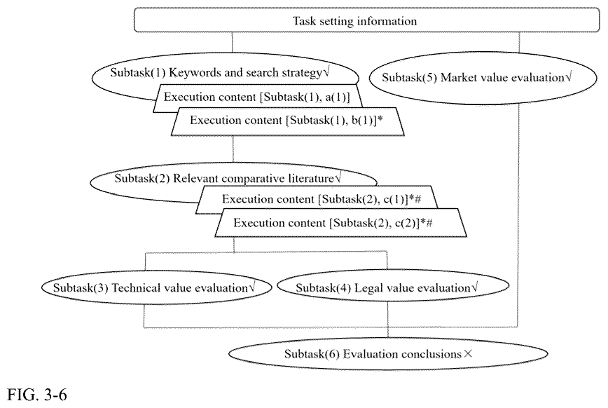

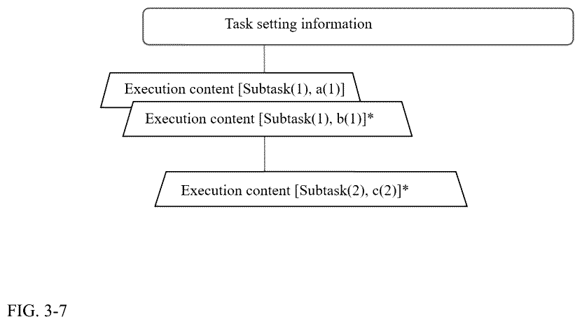

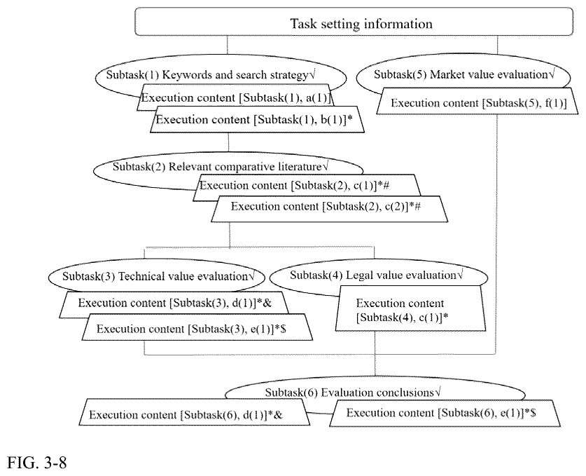

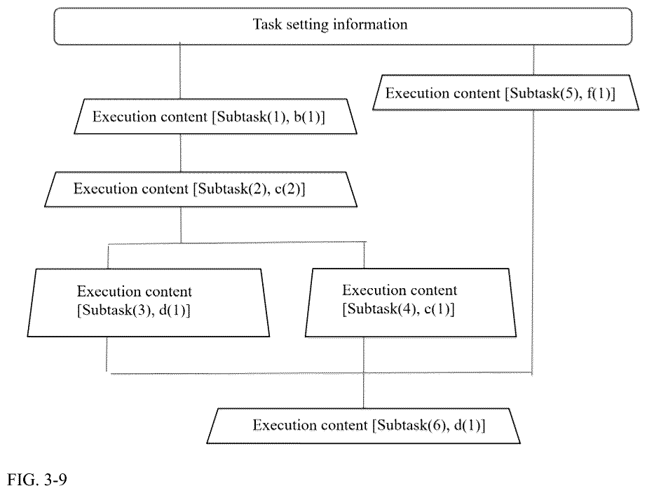

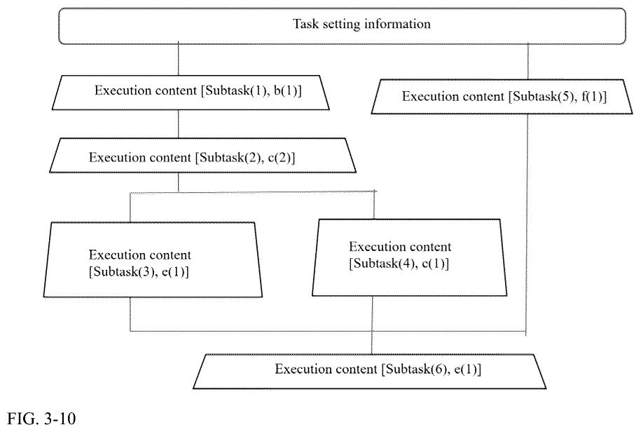

The first task state graph is generated as shown in FIG. 3-1.

Step S3: the Subtask (1) and the Subtask (5) in the creatable state are provided to the creator for the creator to input the created information according to the subtask description information.

A creator A selects the Subtask (1) and inputs the created information according to the task setting information (the patent authorization number input by the task releaser) and the description information (keywords and search strategy) of the subtask. The creation content information in the created information refers to the keywords and search strategy used for literature search.

Step S4: the created information from the creator for the subtask is received, and an execution content corresponding to the subtask is generated.

Step S4.1: the user a generates an execution content data block [Subtask (1), a(1)] for the Subtask (1), including:
The creation content information, configured for the keywords and search strategy for literature search.
The creator identity information, being a public key of the user a.
The content relationship information, including
   the content attribution relationship, execute content [Subtask (1), a(1)] ESubtask (1).
   the content dependency relationship, none.
   the content inheritance relationship, none.
the task identifier, Task_ID (n).
the execution content identifier, [Subtask (1), a(1)].

Step S4.2: the user a uses the private key to digitally sign the execution content data block and generates the digital fingerprint of the execution content data block.

Step S4.3: the server stores the execution content data block, and generates the access address of the execution content data block.

Step S4.4: the user terminal or the server generates the execution content data packet, including the following contents: a storage address of the execution content data block, the digital fingerprint of the execution content data block, and a public key of an execution content releaser.

Step S4.5: the user terminal or the server releases the execution content data packet into a blockchain, to obtain a corresponding access address tokenURI as an execution content data packet index.

Step S5: when there is a subtask node with an execution content in Task_ID (n), the second task state graph is generated. When the subtask node Subtask (1) has the execution content [Subtask (1), a(1)], the second task state graph at this time is as shown in FIG. 3-2.

Step S6: when the atomic-type subtask on which the subtask depends has a plurality of execution contents, the step of setting the subtask to be in the creatable state includes: receiving one execution content selected by the creator from the plurality of execution contents; and setting the subtask to be in the creatable state.

Specifically, when the subtask node Subtask (1) has two execution contents [Subtask (1), a (1)] and [Subtask (1), b(1)], if a creator c does not select one of the two execution contents, the Subtask (2) depending on the subtask node Subtask (1) is set to be in the non-creatable state. At this time, the second task state graph presented by the user terminal to the creator c is as shown in FIG. 3-3.

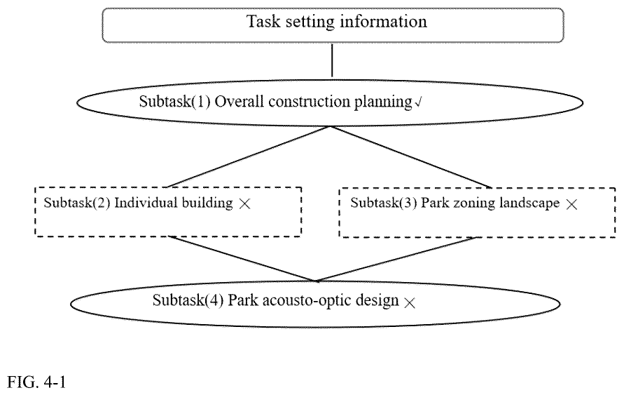

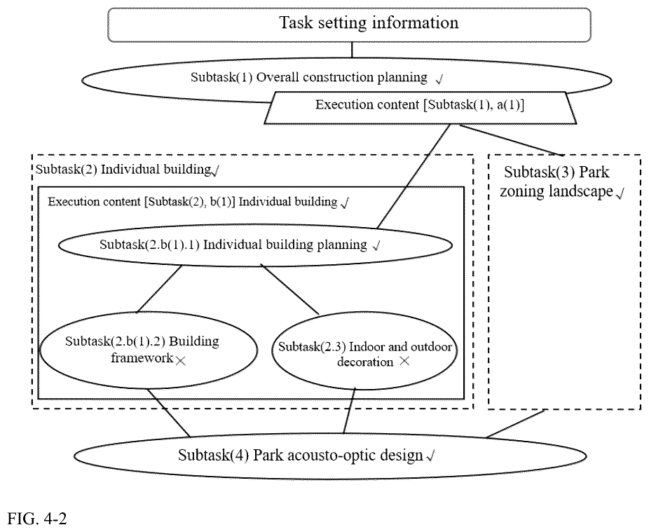

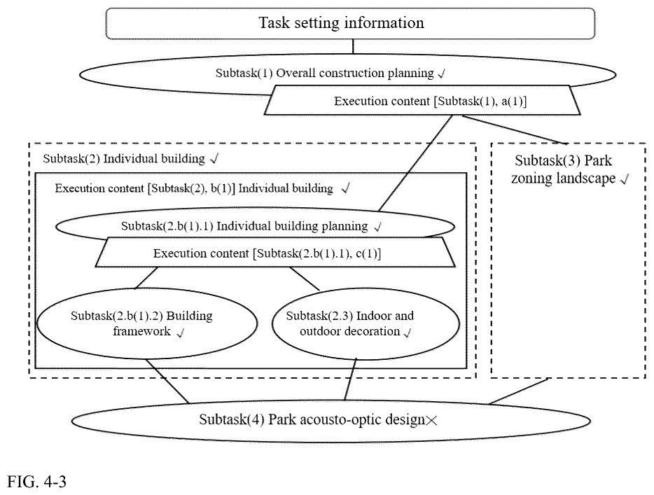

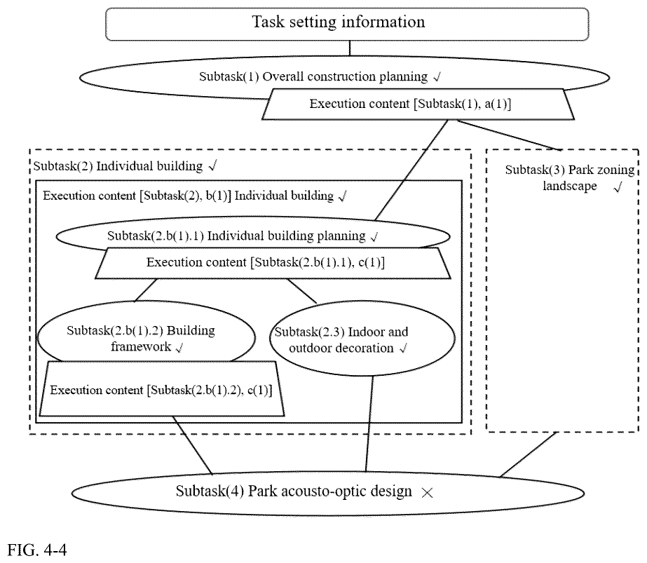

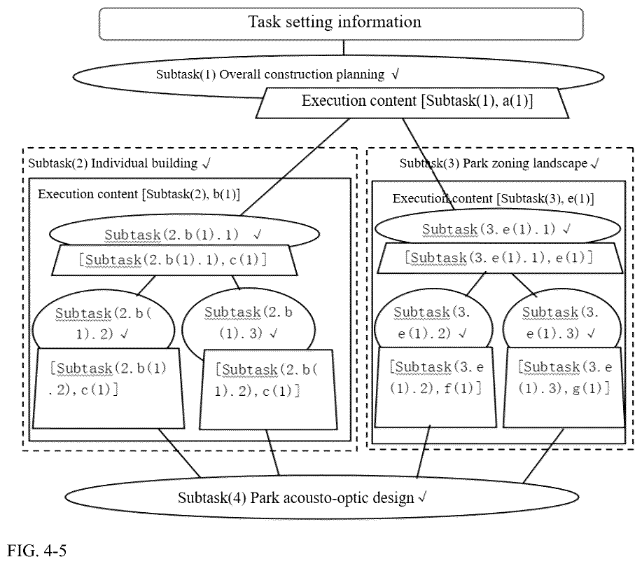

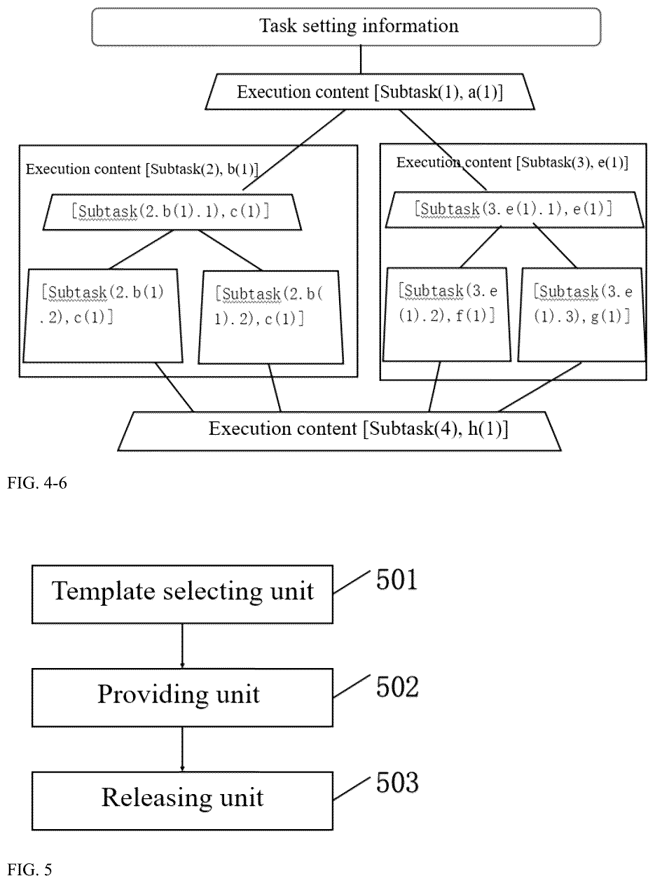

When the creator c selects the [Subtask (1), b(1)] from the two execution contents, then for the creator c, the Subtask (2) is set to be in the creatable state. At this time, the second task state graph presented by the user terminal to the creator c is as shown in FIG. 3-4. The selected execution content is indicated by a symbol “@”.

This means that the execution content [Subtask (2), c(1)] created by the creator c for the Subtask (2) next depends on the execution content node [Subtask (1), b(1)] in terms of the content dependency relationship, or is derived from the execution content node [Subtask (1), b(1)]. At this time, the second task state graph presented by the user terminal to the creator is as shown in FIG. 3-5. The execution content node marked with “*” represents the content dependency relationships with dependency and derivation;

Step S7: the subtask in the creatable state is provided to the creator for the creator to input the created information according to the subtask description information; and the created information from the creator for the subtasks is received, and the execution content corresponding to the subtask is generated. The content inheritance relationship points to a third execution content, both the third execution content and the first execution content belong to the first subtask, and the first execution content is obtained by revising on the basis of the third execution content.

Step S7.1: the creator c selects the execution content node [Subtask (2), c(1)], chooses to revise the execution content, and inputs the created information to the Subtask (2).

Step S7.2: the user terminal or the server of the creator c receives the created information from the creator c for the subtask, and generates an execution content data block [Subtask (2), c(2)], including:
the creation content information, being a patent announcement number.
The creator identity information, being a public key of the user c.
The content relationship information, including
   the content attribution relationship, [Subtask (2), c(2)] ESubtask (2).
   The content dependency relationship, wherein an execution content node [Subtask (3), c(2)] depends on an execution content node [Subtask (1), b(1)].
   The content inheritance relationship, wherein an execution content node [Subtask (2), c(2)] inherits an execution content node [Subtask (2), c(1)].
The task identifier, Task_ID (n).
The execution content identifier, [Subtask (3), c(2)].

Step S8: a process of generating the execution content corresponding to the subtask further including: generating the second task state graph. Specifically, after generating the execution content data block from the execution content nodes [Subtask (2), c(2)], the second task state graph presented by the user terminal to the user c is as shown in FIG. 3-6. The execution content node marked with “#” represents the content inheritance relationship with inheritance and revision.

Step S9: a digital work information snapshot is generated when an execution content node of an atomic-type subtask exists in the second task state graph, or when the execution content node of the atomic-type subtask and an execution content node of a next-level atomic-type subtask both exist in the second task state graph, or when the execution content node of the next-level atomic-type subtask exists in the second task state graph, wherein the information snapshot includes: the execution content nodes; or the execution content nodes and a content dependency relationship among the execution content nodes.

After generating the execution content data block from the execution content nodes [Subtask (2), c(2)], an information snapshot of the second task state graph presented by the user terminal to the user c is as shown in FIG. 3-7. The execution content node [Subtask (2), c(1)] is no longer present in the information snapshot because it has been replaced by the inherited execution content node [Subtask 2), c(2)].

Step S10: the Task_ID (n) does not have any framework-type subtask node, and has all atomic-type subtask nodes. When each subtask node of Task_ID (n) has the execution content, the second task state graph is as shown in FIG. 3-8. The execution content nodes marked with “*” “&” and “$” indicate that the execution content nodes with the same mark have a content dependency relation of the dependency-derivation; and the execution content node marked with “#” indicates that the execution content nodes with the same mark have a content inheritance relationship of inheritance-revision.

Based on the user's request to view the complete draft information snapshot of the digital work and the user's unique selection of the plurality of execution content nodes belonging to the same subtask, the user terminal or the server generates the complete draft information snapshot of the digital work and presents the complete draft information snapshot to the user. Each atomic-type subtask node has the unique execution content node, and the content dependency relationship exists among the execution content nodes respectively owned by subtask nodes having the dependency relationship.

For example, a user d sends a request to view the complete draft information snapshot and selects the [Subtask (3), d(1)] from the two execution contents of Subtask (3). The complete draft information snapshot presented to the user d by the user terminal is as shown in FIG. 3-9.

A user e sends a request to view the complete draft information snapshot and selects the [Subtask (3), e(1)] from the two execution contents of Subtask (3). The complete draft information snapshot presented to the user e by the user terminal is as shown in FIG. 3-10.

Step S11: the complete draft of the Task_ID (n) is viewed.

S11.1: a user h requests to view the complete draft information snapshot of the Task_ID (n) through the user terminal.

S11.2: according to the aforementioned step S10, after selection of the user h, the user terminal or the server generates the complete draft information snapshot of the Task_ID (n).

S11.3: the user terminal or the server generates the digital work complete draft by combining the task template, the task setting information, and the complete draft information snapshot. S11.3 specifically includes the following steps:
the execution content is extracted from the complete draft information snapshot of the digital work. A first content generation manner for generating a creation content block is extracted from the task template. According to the first content generation manner, a work content of the creation content block object is generated based on the execution content.

A setting content block generation manner is extracted from the task template. According to the setting content block generation manner, a work content of the setting content block object is generated based on the task setting information.

Each default content block is extracted from the task template.

According to the content block display attribute and the content block relationship attribute of each creation content block, each setting content block, and each default content block, the user terminal or the server assembles the work contents of the aforementioned content block objects to generate the digital work complete draft.

In a process of generating the digital work draft, examples of a processing procedure of finally generating a work content of a setting content block SCblock (2) in the digital work according to the task setting information are as follows:

The task setting information input by the task releaser is the patent announcement number. According to the content generation manner of the setting content block included in the task template, the terminal or the server searches a public document of the patent by using the patent announcement number as a keyword. A content of the “patent abstract” is intercepted from the file as the work content of the setting content block SCblock (2) object. The terminal or the server assembles the work content of the content block object into the digital work according to a content block relationship attribute and a content block display attribute of the setting content block SCblock (2). The content generation manner is saved in a meta tag of a task template HTML file in a form of script functions, and information processing required for content generation is completed by executing the codes of the script functions.

In a process of generating the digital work draft, examples of a processing procedure of finally generating a work content of a creation content block CCblock (1) in the digital work according to the execution content of the subtask are as follows:
the creator inputs the corresponding content of the keywords and the search strategy in the Subtask (1), sets the presentation forms such as fonts and layout formats, and incorporates the same into the creation content information of the execution content of the subtask. The terminal or the server extracts the content information from the creation content information of the Subtask (1) execution content, and copies the work content of generating the creation content block CCblock (1) object according to the first content generation manner included in the task template. The terminal or the server assembles the work content of the content block object into the digital work according to a content block relationship attribute and a content block display attribute of the creation content block CCblock (1). The above content generation relationship is saved in a meta tag of a task template HTML file in a form of script functions, and information processing required for content generation is completed by executing the codes of the script functions.

S11.4: the user terminal presents the digital work complete draft.

Step S12: in all the current complete draft information snapshots of the Task_ID (n), the task releaser (user A) selects one complete draft information snapshot as a final draft information snapshot for this collaborative creation task and releases it. Step S12 specifically includes the following steps:

S12.1: the user A generates a final draft information snapshot data block of the Task_ID (n) through the user terminal, and the data block includes the following contents: the task identifier Task_ID (n), an execution content data packet index of each execution content node in the final draft information snapshot, and the task releaser identity information.

S12.2: the user A uses a private key to digitally sign the final draft information snapshot data block and generate a digital fingerprint of the data block.

S12.3: the server stores the final draft information snapshot data block and generates an access address of the data block.

S12.4: the user terminal or the server generates a final draft information snapshot data packet, including the following contents: the access address of the final draft information snapshot data block, the digital fingerprint of the final draft information snapshot data block, and a public key of the user A.

S12.5: The user terminal or the server releases the final draft information snapshot data packet into the blockchain and obtains a corresponding blockchain access address as a final draft information snapshot data packet index.

Step S13: the task ends. The collaborative creation of the Task_ID (n) is completed, and the server sets all subtasks of the Task_ID (n) to be in a non-creatable state for all users. Afterwards, users who have the permission to browse or download the complete draft can still make a request to view or download the Task_ID (n) complete draft through the user terminal.

According to the digital work collaborative creation method in this embodiment, the collaborative creation task is divided into the plurality of subtasks with the dependency relationship for the creators to create, and the creators are enabled to independently select the content dependency relationship and the inheritance relationship, thereby achieving survival of the fittest of the execution content and promoting the improvement of the overall quality of the digital work. This embodiment further stores the collaborative creation task released by the task releaser and the execution content created by the subtask creator on the blockchain, which has the characteristics of tamper proofness and non-repudiation, thereby providing basic conditions for operation of economic systems such as authentic right and rights distribution of subsequent contents.

The embodiment of the present application further provides an embodiment of a collaborative creation task for a theme park in a metaverse virtual space. The digital work created for this task is “Metaverse Theme Park”. This task template contains the framework-type subtask.

Y1, Make and release a collaborative creation task template for the metaverse theme park

A task template maker completes making of the task template. Afterwards, the task template is stored in a digital work collaborative creation task template library, a globally unique task template identifier a(m) (which may be a character string or a string of binary codes) is generated, and a task template access address is generated and released.

As an example, the collaborative creation task template for the metaverse theme park contains template description information, a task setting object, and subtasks. The template description information is that “This is a collaborative creation task for a metaverse theme park. Please input the task setting information in the task setting object”.

The subtasks include subtask description information, and a dependency relationship exists among the subtasks. As shown in the table below:

| Subtask | | Subtask dependency |
|---|---|---|
| identifier | Subtask description information | relationship |
| Subtask(1) | Atomic-type subtask, overall | Not depending on other |
| | construction planning | subtasks |
| Subtask(2) | Framework-type subtask, | Depending on Subtask(1) |
| | individual building | |
| Subtask(3) | Framework-type subtask, park | Depending on Subtask(1) |
| | zoning landscape | |
| Subtask(4) | Atomic-type subtask, park | Depending on Subtask(2), |
| | acousto-optic design | Subtask(3) |

Y2, Set and release a collaborative creation task for the metaverse theme park

Step R1: a user A browses a digital work collaborative creation task template library in the server through the user terminal, and selects a collaborative creation task template a(m) of the “Metaverse Theme Park” from it.

Step R2: the user terminal displays a task template content.

Step R3: the user A inputs task setting information through the user terminal: a music themed park is built, a location of a site in the metaverse virtual space is YYY, there is a square that can hold large-scale music party, there are three music peripheral product display and trading spaces, and there is a digital model with a logo of a park owner and LOGO modelling at an entrance and a significant location of the park.

Step R4: a collaborative creation task Task_ID (n) is generated and released according to the task setting information and the task template.

Y3, Collaborative creation for the metaverse theme park

Step S1: the user a obtains a Task_ID (n) to be collaboratively created from the server through the user terminal.

Step S2: the user a obtains creation states of the subtasks through the user terminal, wherein the creation states include a creatable state and a non-creatable state, and the creation states are set according to the dependency relationship among the subtasks.

Subtask (1) which does not depend on other subtasks and can be directly created is set to in a creatable state. The other subtasks are set to be in a non-creatable state.

The subtasks in the creatable state are marked with a symbol v and may be selected by the creator to input created information.

The subtasks in the non-creatable state are marked with a symbol x and cannot be selected by the creator to input the created information.

The first task state graph is generated as shown in FIG. 4-1. The atomic-type subtask nodes are represented by elliptical boxes, while the framework-type subtask nodes are represented by rectangular boxes.

Step S3: a subtask in the creatable state is provided to a creator for the creator to input created information according to the subtask description information.

As an example, the Subtask (1) already has an execution content node [Subtask (1), a(1)], whose creation content information includes data configured to describe the overall construction planning of the metaverse theme park. A creator B selects the framework-type subtask (2) that can be created at this time. The creation content information is input according to the description information (the framework-type subtask, individual building) of the subtask and the creation content information in the execution content nodes [Subtask (1), a(1)]. The creation content information is a collaborative creation template of the framework-type subtask and includes the following contents:
1) a setting object for an execution content of the framework-type subtask. The set object is provided to an execution content creator b for the execution content creator to input execution content setting information according to the subtask description information: constructing the individual building according to the creation content information of “overall construction planning” in the execution content node [Subtask (1), a(1)]. The individual building needs to have three music peripheral product display and trading spaces.
2) Next-level subtasks and a dependency relationship among the next-level subtasks.

| Next-level subtask | Next-level subtask | Next-level subtask |
|---|---|---|
| identifier | description information | dependency relationship |
| Subtask(2.b(1).1) | Atomic-type subtask, individual | Not depending on other |
| | building planning | next-level subtasks |
| Subtask(2.b(1).2) | Atomic-type subtask, building | Depending on |
| | framework | Subtask(2.b(1).1) |
| Subtask(2.b(1).3) | Atomic-type subtask, indoor and | Depending on |
| | outdoor decoration | Subtask(2.b(1).1) |

3) An attribution relationship between the next-level subtasks and the execution content of the subtask, wherein the attribution relationship is configured to indicate that the execution content of the subtask owns the next-level subtasks. The next-level subtasks such as Subtask (2.b (1).1), Subtask (2.b (1).2), and Subtask (2.b (1).3) belong to the execution content [Subtask (2), b(1)].
4) A content dependency relationship between the next-level subtask and execution contents of other subtasks, pointing to the execution contents of other subtasks on which the execution content of the subtask depends. The next-level subtask Subtask (2.b (1).1) depends on the subtask execution content [Subtask (1), a(1)].
5) A dependency relationship between other subtasks and the next-level subtask, pointing to the next-level subtask. A subtask (4) depends on the next-level subtasks Subtask (2.b (1).2) and 18 Subtask (2.b (1).3).

Step S4: the created information from the creator for the subtask is received, and an execution content corresponding to the subtask is generated.

Step S4.1: a user b generates an execution content data block for the execution content node [Subtask (2), b(1)] of the Subtask (2), including:
creation content information, including a collaborative creation template of the aforementioned framework-type subtask created by the creator b.
Creator identity information, generated based on the creator. The creator identity information may specifically be a public key of the user a.
The content relationship information, including
   a content attribution relationship, being an attribution relationship between the execution content of the subtask and the subtask, wherein the attribution relationship is configured to indicate that the subtask owns the execution content. The content attribution relationship is specifically [Subtask (2), b(1)] ESubtask (2). 12
   The content dependency relationship, wherein an execution content [Subtask (2), b (1)] depends on an execution content [Subtask (1), a(1)].
   The content inheritance relationship, none.
The task identifier, Task_ID (n).
The execution content identifier, [Subtask (2), b(1)].

Step S4.2: the user b uses the private key to digitally sign the execution content data block and generates the digital fingerprint of the execution content data block.

Step S4.3: the server stores the execution content data block, and obtains an access address of the execution content data block, which may be a URI or a HASH address a data block file.

Step S4.4: the user terminal or the server generates the task data packet, at least including the following contents: a storage address of the execution content data block, the digital fingerprint of the execution content data block, and a public key of an execution content creator.

Step S4.5: the user terminal or the server releases the execution content data packet into the selected blockchain and obtains the blockchain access address as the execution content data packet index.

Step S5: a second task state graph is generated as shown in FIG. 4-2. Wherein, the subtasks in step S4, the next-level subtasks, as well as various dependency relationships and content relationships among them are covered.

Step S6: if the creator selects one or more execution contents in the first subtask, the second subtask is set to be in the creatable state when atomic-type next-level subtasks owned by the one or more selected execution contents all have execution contents and all atomic-type subtasks on which the subtask depends have execution contents; and the second subtask is set to be in the non-creatable state when one of the atomic-type next-level subtasks owned by the one or more selected execution contents does not have an execution content, or one of the atomic-type subtasks on which the subtask depends does not have an execution content.

A creator c selects the atomic-type next-level subtask Subtask (2.b (1). 1) individual building planning in the execution content node [Subtask (2), b(1)] of the Subtask (2) individual building construction to input the created information and generate the execution content node [Subtask (2.b (1).1), c(1)] of the atomic-type next-level subtask. The creation content information includes data configured to describe the individual building planning of the metaverse theme park. At this time, the second task state graph displayed on the user terminal of the creator c is as shown in FIG. 4-3. For the creator c, the atomic-type subtask Subtask (4) park acousto-optic design in the second task state graph turns to the non-creatable state, while the atomic-type next-level subtask Subtask (2.b (1).2) building frame and Subtask (2.b (1).3) indoor and outdoor decoration turn to the creatable state.

Step S6.5: A creator c selects the atomic-type next-level subtask Subtask (2.b (1).2) building frame design in the execution content node [Subtask (2), b(1)] of the Subtask (2) individual building construction to input the created information and generate the execution content node [Subtask (2.b (1). 1), c(1)] of the atomic-type next-level subtask. At this time, the second task state graph generated by a system for the creator c and displayed on the user terminal is as shown in FIG. 4-4. The creation content information of the atomic-type next-level subtask Subtask (2.b (1).2) includes three-dimensional model data, configured to describe the building framework.

Step S7: when a first subtask is the framework-type subtask and a second subtask depends only on the first subtask, the step of setting the creation states according to the dependency relationship among the subtasks includes: receiving the execution content in the first subtask selected by the creator; and setting the second subtask to be in the creatable state when the atomic-type next-level subtasks owned by the selected execution content all have execution contents.

When the Subtask (2) has the execution content [Subtask (2), b(1)], the Subtask (3) has the execution content [Subtask (3), e(1)], and the next-level atomic-type subtasks in the execution content all have execution contents, a creator t selects the execution content [Subtask (2), b(1)] and the execution content [Subtask (3), e(1)]. Similar to selecting one execution content when the atomic-type subtask has a plurality of execution contents, a creator t needs to select one execution content from the plurality of execution contents owned by the next-level atomic-type subtask. The above selection made by the creator t makes the Subtask (4) park acousto-optic design become a creatable state. As shown in FIG. 4-5.

Step S8: when the atomic-type subtask nodes and the framework-type subtask nodes exist in the second task state graph, all the atomic-type subtask nodes have execution content nodes, and the atomic-type next-level subtasks owned by the selected execution contents in the execution contents owned by the framework-type subtask nodes all have execution content nodes, a complete draft information snapshot of the digital work is generated according to the user's requirement to view the complete draft information snapshot of the digital work.

To generate the complete draft information snapshot of the digital work, the user needs to make a selection on the plurality of execution contents of the framework-type subtask. According to the user's selection, the complete draft information snapshot presented by the user terminal is as shown in FIG. 4-6.

Step S9: the digital work complete draft of the Task_ID (n) is viewed.

S9.1: a user A requests to view the digital work complete draft of the Task_ID (n) through the user terminal.

S9.2: according to the aforementioned step S8, after selection of the user A, the user terminal or the server generates the complete draft information snapshot of the digital work of the Task_ID (n).

S9.3: the user terminal or the server generates the digital work complete draft based on the complete draft information snapshot of the digital work. S9.3 specifically includes the following steps:

The user terminal or the server extracts the execution content of the atomic-type subtask and the execution content of the atomic-type next-level subtask owned by the execution content of the selected framework-type subtask from the complete draft information snapshot of the digital work.

For the execution content of the selected framework-type subtask, a work content corresponding to the execution content of the selected framework-type subtask is generated according to the creation content information in the execution content of the atomic-type subtask owned by the execution content.

The digital work complete draft is generated according to the creation content information of the execution content of the atomic-type subtask, and the work content of the execution content of the selected framework-type subtask.

The metaverse theme park belongs to the category of compound information digital works, with data types including texts, vector graphics, images, audio and video, and so on. The complete draft may be saved as a hierarchical data file (HDF) format file.

S9.4: the user terminal presents the digital work complete draft.

Step S10: in all the current complete draft information snapshots of the Task_ID (n), the task releaser (user A) selects one complete draft information snapshot as a final draft information snapshot for this collaborative creation task and releases it.

Step S11: the task ends.

The digital work collaborative creation method in this embodiment supports the setting of the framework-type subtask in the collaborative creation task, which can support collaborative creation of more types of digital works such as park construction in the metaverse virtual space and environmental evaluation reports for construction projects. One atomic-type subtask must have one and only one execution content to be incorporated in a complete draft information snapshot of the digital work. In contrast, one framework-type subtask may have 0 or 1 or more execution contents to be incorporated in a complete draft information snapshot of the digital work. The specific number of the execution contents incorporated in the complete draft information snapshot for the framework-type subtask is determined by the creator and task releaser according to actual needs of the task. For example, in the above embodiments, the number of the execution content of the framework-type subtask “individual building” incorporated in the final draft information snapshot depends on the number of individual buildings planned in the execution content of the “overall construction planning” selected by the task releaser. If the number of the individual buildings planned in the execution content of the “overall construction planning” selected by the task releaser is 2, then the number of the execution contents of the framework-type subtask “individual building” incorporated in the final draft information snapshot is 2.

This embodiment further provides an apparatus for releasing a digital work collaborative creation task, as shown in FIG. 5, including:
a template selecting unit 501, configured to obtain a selected task template, wherein the task template includes template description information, a task setting object, and subtasks, each of the subtasks includes subtask description information, and a dependency relationship exists among the subtasks;
a providing unit 502, configured to provide the task setting object to a task releaser for the task releaser to input task setting information; and
a releasing unit 503, configured to generate and release a collaborative creation task according to the task setting information input by the task releaser and the task template.

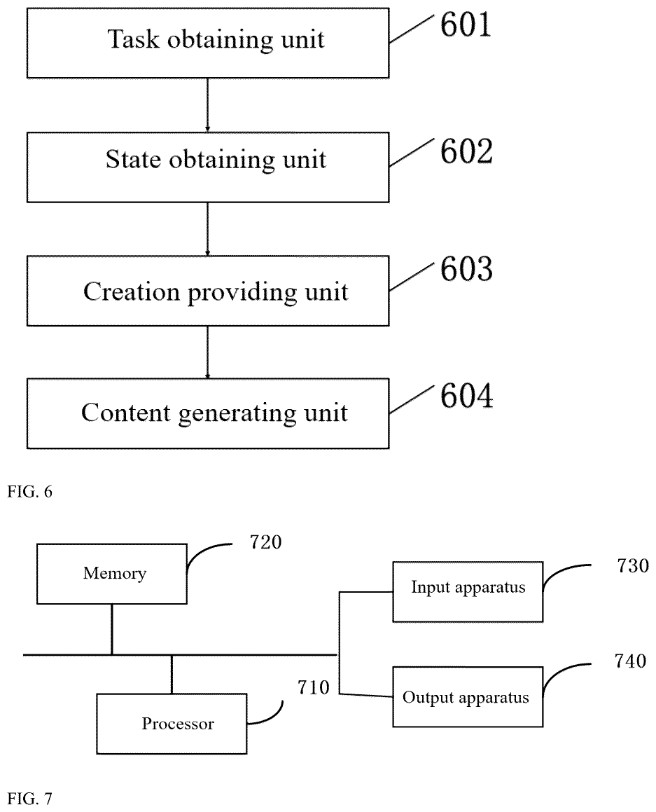

This embodiment further provides a digital work collaborative creation apparatus, as shown in FIG. 6, including:
a task obtaining unit 601, configured to obtain a collaborative creation task, wherein the collaborative creation task includes a plurality of subtasks, each of the subtasks includes subtask description information, and a dependency relationship exists among the subtasks;
a state obtaining unit 602, configured to obtain creation states of the subtasks, wherein the creation states include a creatable state and a non-creatable state, and the creation states are set according to the dependency relationship among the subtasks;
a creation providing unit 603, configured to provide a subtask in the creatable state to a creator for the creator to input created information according to the subtask description information; and
a content generating unit 604, configured to receive the created information from the creator for the subtask, and generate an execution content corresponding to the subtask.

For specific limitations and beneficial effects, reference may be made to the foregoing, and details will not be repeated here. Each module above may be implemented entirely or partially through software, hardware, or a combination thereof. All the above modules may be embedded in or independent of a processor in a computer device in a hardware form, or stored in a memory in the computer device in a software form for the processor to call and execute the operations corresponding to all the above modules.

FIG. 7 is a schematic diagram of a hardware structure of a computer device provided by an embodiment of the present application. As shown in FIG. 7, the device includes one or more processors 710 and a memory 720, and the memory 720 includes a persistent memory, a volatile memory, and a hard disk. In FIG. 7, a processor 710 is taken as an example. The device may further include an input apparatus 730 and an output apparatus 740.

The processor 710, the memory 720, the input apparatus 730 and the output apparatus 740 may be connected through a bus or other modes. In FIG. 7, a bus connection is taken as an example.

The processor 710 may be a central processing unit (CPU). The processor 710 may further be other general purpose processors, digital signal processors (DSPs), application specific integrated circuits (ASICs), field-programmable gate arrays (FPGAs) or other programmable logic devices, discrete gate or transistor logic devices, discrete hardware components and other chips, or a combination of the various types of chips above. The general-purpose processor may be a microprocessor or this processor may also be any conventional processor, etc.

As a non-transient computer-readable storage medium, the memory 720 includes a persistent memory, a volatile memory, and a hard disk, and may be used to store non-transient software programs, non-transient computer executable programs and modules, such as program instructions/modules corresponding to the service management method in the embodiment of the present application. The processor 710 executes various functional applications and data processing of the server by running the non-transient software programs, instructions and modules stored in the memory 720, that is, implements the method above.

The memory 720 may include a storage program area and a storage data area, wherein the storage program area may store the application program required by operating the system and at least one function; and the storage data area may store data used as needed, and the like. In addition, the memory 720 may include a high-speed random access memory and a non-transient memory, such as at least one disk storage device, a flash memory device, or other non-transient solid-state storage devices. In some embodiments, the memory 720 optionally includes memories arranged remotely relative to the processor 710, and theses remote memories may be connected to a data processing apparatus through a network. Instances of the above network include but not limited to an Internet, an intranet, a local area network, a mobile communication network and their combination.

The input apparatus 730 may receive input numerical or character information, as well as generate key signal inputs related to user settings and function controls. The output apparatus 740 may include display devices such as a display screen.

The one or more modules are stored in the memory 720. When executed by the one or more processors 710, the method above is executed.

The above product may execute the method provided by the embodiments of the present application, and has corresponding functional modules and beneficial effects for executing the method. For technical details not described in detail in this embodiment, please refer to the relevant descriptions in the embodiments shown in FIG. 1 and FIG. 2.

An embodiment of the present application further provides a non-transient computer storage medium, the computer storage medium stores computer executable instructions, and the computer executable instructions can execute any of the authentication methods in the above embodiments. The storage media may be a magnetic disk, an optical disk, a read-only memory (ROM), a random access memory (RAM), a flash memory, a hard disk drive (HDD), or a solid-state drive (SSD). The storage medium may further include the combination of the above types of memories.

Those skilled in the art can understand that implementation of all or part of flows in methods of the above embodiments can be completed by instructing relevant hardware through computer programs. The programs can be stored in a computer readable storage medium. The program, when executed, may include the flow of the embodiments of the above methods. The storage medium may be a magnetic disk, an optical disk, a read-only memory (ROM), or a random access memory (RAM), etc.

Obviously, the above embodiments are only examples for clear explanation, not for limitation of the implementations. For those ordinarily skilled in the art, other changes or variations in different forms can further be made on the basis of the above description. It is unnecessary and impossible to enumerate all the implementations here. The obvious changes or variations arising therefrom are still within the protection scope of the present application.

1. A digital work collaborative creation method, comprising:
obtaining a collaborative creation task, wherein the collaborative creation task comprises a plurality of subtasks, each of the subtasks comprises subtask description information, and a dependency relationship exists among the subtasks;
obtaining creation states of the subtasks, wherein the creation states comprise a creatable state and a non-creatable state, and the creation states are set according to the dependency relationship among the subtasks;
providing a subtask in the creatable state to a creator for the creator to input created information according to the subtask description information; and
receiving the created information from the creator for the subtask, and generating an execution content corresponding to the subtask;
wherein the execution content of the subtask at least comprises:
creation content information, comprising the content information input by the creator for the subtask;
creator identity information, generated based on the creator; and
content relationship information, comprising a content attribution relationship which is an attribution relationship between the execution content of the subtask and the subtask, wherein the attribution relationship is configured to indicate that the subtask owns the execution content;
wherein, when a first subtask depends on a second subtask and a first execution content belongs to the first subtask, the content relationship information of the first execution content further comprises:
a content dependency relationship, pointing to a second execution content, from which the first execution content is derived, in execution contents owned by the second subtask; and/or
a content inheritance relationship, pointing to a third execution content, wherein both the third execution content and the first execution content belong to the first subtask, and the first execution content is obtained by revising on the basis of the third execution content.

2. The method according to claim 1, wherein the collaborative creation task comprises a task template, and the task template comprises template description information, a task setting object, and the subtasks;
the template description information is configured to describe the task template;
the task setting object is configured for a task releaser to input task setting information;
the subtasks comprise the subtask description information, and the dependency relationship exists among the subtasks;
the subtasks are configured to be provided to the creator for the creator to input the created information according to the subtask description information;
the dependency relationship among the subtasks is configured for setting the creation states of the subtasks;
and/or
the task template further comprises a creation content block of a digital work and a first content generation manner;
the creation content block of the digital work comprises a content block object, a content block display attribute, and a content block relationship attribute;
the content block object is configured for inputting a work content;
the content block display attribute is configured to describe a display form of the work content of the content block object in the digital work;
the content block relationship attribute is configured to describe a mutual relationship between the content block and other content blocks in the digital work;
the first content generation manner is configured to describe a manner of generating the creation content block from the execution content of the subtask; and
the collaborative creation task further comprises task setting information, the task setting information is configured to be provided to the creator for the creator to input the created information according to the task setting information and the subtask description information.

3. The method according to claim 1, wherein the creation content information comprises:
next-level subtasks, comprising next-level subtask description information configured to be provided to the creator for the creator to input the created information according to the next-level subtask description information;
an attribution relationship between the next-level subtasks and the execution content of the subtask, wherein the attribution relationship is configured to indicate that the execution content of the subtask owns the next-level subtasks;
and/or
a dependency relationship among the next-level subtasks, configured for setting the creation states of the next-level subtasks.

4. The method according to claim 3, wherein the dependency relationship for the execution content of the subtask that owns the next-level subtasks further comprises:
a dependency relationship between the next-level subtasks and execution contents of other subtasks, pointing to the execution contents of other subtasks on which the execution content of the subtask depends;
and/or
a dependency relationship between other subtasks and the next-level subtasks, pointing to the next-level subtasks.

5. The method according to claim 1, wherein the step of obtaining a collaborative creation task comprises: obtaining a task identifier of the collaborative creation task, wherein the task identifier is a globally unique identifier generated when the collaborative creation task is released;
and/or
the step of generating an execution content corresponding to the subtask comprises: generating an execution content data block, wherein the execution content data block comprises creation content information, content relationship information, and/or the task identifier, and/or creator identity information; and the content relationship information comprises content attribution relationship, and/or content dependency relationship, and/or content inheritance relationship;
and/or
the step of generating an execution content corresponding to the subtask further comprises: storing the execution content data block, generating an access address of the execution content data block, generating an execution content data packet, and releasing the execution content data packet into a blockchain, wherein the execution content data packet comprises the access address of the execution content data block, and/or a digital fingerprint of the execution content data block generated according to the execution content data block.

6. The method according to claim 1, further comprising forming a first task state graph according to the subtasks and the dependency relationship existing among the subtasks, wherein nodes of the first task state graph comprise the subtasks, and a relationship among the nodes comprises the dependency relationship among the subtasks.

7. The method according to claim 6, wherein a process of generating the execution content corresponding to the subtask further comprises:
generating a second task state graph, wherein nodes of the second task state graph comprise subtask nodes and execution content nodes, the subtask nodes comprise the subtasks, the execution content nodes comprise the execution contents of the subtasks, and a relationship among the nodes comprises the dependency relationship among the subtasks, content attribution relationship between the execution contents and the subtasks, and/or content dependency relationship between the execution contents, and/or content inheritance relationship between the execution contents.

8. The method according to claim 6, wherein the step of providing a subtask in the creatable state to a creator for the creator to input created information according to the subtask description information comprises:
displaying the first task state graph or the second task state graph;
setting a subtask in the creatable state to a mode in which the subtask is displayed in a first manner and is able to be selected for creation by the creator; and
setting a subtask in the non-creatable state to a mode in which the subtask is displayed in a second manner and is unable to be selected for creation by the creator, wherein the second manner is different from the first manner;
and/or
a subtask type of a subtask with creation content information that comprises next-level subtasks is a framework-type subtask, and a subtask type of a subtask with creation content information that does not comprise next-level subtasks is an atomic-type subtask;
generating a digital work information snapshot when an execution content node of an atomic-type subtask exists in the second task state graph, or when an execution content node of an atomic-type subtask and an execution content node of a next-level atomic-type subtask both exist in the second task state graph, or when an execution content node of a next-level atomic-type subtask exists in the second task state graph, wherein the information snapshot comprises:
the execution content nodes;
or the execution content nodes and a content dependency relationship among the execution content nodes;
and/or
generating a digital work draft according to the execution content.

9. The method according to claim 1, wherein a process of setting the creation states according to the dependency relationship among the subtasks comprises:
setting a subtask that does not depend on any other subtask and is able to be directly created to be in a creatable state;
setting a subtask that is only able to be created by depending on one or more other subtasks to be in a creatable state when all atomic-type subtasks on which this subtask depends have execution contents; and setting this subtask to be in a non-creatable state when one of the atomic-type subtasks on which this subtask depends does not have an execution content.

10. The method according to claim 9, wherein when an atomic-type subtask on which the subtask depends has a plurality of execution contents, the step of setting the subtask to be in a creatable state comprises:
receiving one execution content selected by the creator from the plurality of execution contents; and
setting the subtask to be in the creatable state.

11. The method according to claim 3, wherein, when a first subtask is a framework-type subtask and a second subtask depends only on the first subtask, the step of setting the creation states according to the dependency relationship among the subtasks comprises:
receiving execution content in the first subtask selected by the creator; and
setting the second subtask to be in the creatable state when atomic-type next-level subtasks owned by the selected execution content all have execution contents.

12. The method according to claim 3, wherein, when a first subtask is a framework-type subtask and a second subtask depends on the first subtask and one or more other atomic-type subtasks, the step of setting the creation states according to the dependency relationship among the subtasks comprises:
if the creator does not select the execution content in the first subtask;
setting the second subtask to be in the creatable state when all the atomic-type subtasks on which the subtask depends have execution contents; and setting the second subtask to be in the non-creatable state when one of the atomic-type subtasks on which the subtask depends does not have an execution content;
or
if the creator selects one or more subtask execution contents in the first subtask;
setting the second subtask to be in the creatable state when atomic-type next-level subtasks owned by the one or more selected execution contents all have execution contents and all atomic-type subtasks on which the subtask depends have execution contents; and setting the second subtask to be in the non-creatable state when one of the atomic-type next-level subtasks owned by the one or more selected execution contents does not have an execution content, or one of the atomic-type subtasks on which the subtask depends does not have an execution content.

13. An electronic device, comprising: a memory and a processor, wherein the memory and the processor are in communicational connection with each other, the memory has computer instructions stored therein, and the processor is configured to execute the digital work collaborative creation method according to claim 1 by executing the computer instructions.

14. A computer-readable storage medium, wherein the computer-readable storage medium has computer instructions stored therein, and the computer instructions are configured to cause a computer to execute the digital work collaborative creation method according to claim 1.
